(19) United States
(12) Patent Application Publication
(10) Pub. No.: US 2024/0003623 A1
(43) Pub. Date: Jan. 4, 2024

(54) RADIO FREQUENCY MOISTURE-REMOVAL

(71) Applicant: DRYMAX DDG LLC, Eden Prairie, MN (US)

(72) Inventor: Kevin EICHHORN, Chanhassen, MN (US)

(21) Appl. No.: 18/253,844

(22) PCT Filed: Nov. 22, 2021
(86) PCT No.: PCT/US2021/060312

§ 371 Date: May 22, 2023

Related U.S. Application Data
(60) Provisional application No. 63/116,442, filed on Nov. 20, 2020.

(51) Int. Cl. F26B 3/347; F26B 25/22; F26B 9/06; F26B 3/34; A23B 9/08

(52) U.S. Cl. CPC F26B 3/347; F26B 25/22; F26B 9/066; F26B 3/343; A23B 9/08; F26B 2200/02; F26B 2200/06; F26B 2200/14

(57) ABSTRACT

Systems and methods of grain drying using radio frequency waves while maintaining low temperature are disclosed herein. Specifically, the system and method includes minimizing temperature increases caused by dielectric radio frequency heating while increasing intermolecular hydrogen bond disruption. Further disclosed herein are devices systems and methods for removing moisture from a material via radio frequency electromagnetic wave exposure.

### PRIORITY CLAIM

The present application is a National Phase entry of PCT Application No. PCT/US2021/060312, filed Nov. 22, 2021, which claims priority from U.S. Provisional Patent Application No. 63/116,442, filed Nov. 20, 2020, each of which is hereby fully incorporated herein by reference.

### TECHNICAL FIELD

The present invention relates to moisture-removal systems utilizing electromagnetic radio-frequency fields to remove water from different materials including agricultural biomass products such as harvest crops, grains, fruits, etc., waste materials such as manure, human waste etc., and inorganic materials such as construction aggregate materials, wet sand etc.

### BACKGROUND

Agricultural harvest crops, such as corn and grain, require drying after harvest to prevent molding and other bacteria growth, spontaneous internal combustion, and other spoilage. The simplest method of drying is spread-type air drying where the harvested crop is spread out over a large area and air dried. Spread-type air drying uses the small amount of energy but impractical for even most harvest due to space and time constraints. An improved method of drying harvest crops is heat assisted air drying. Heat assisted air drying is prevalent in much of today's commercial and smaller scale agricultural harvest crop production.

In conventional heat assisted air drying, the harvest crops are loaded into drying bins that force heated air through the harvest crop until the harvest crop is at a required moisture level. To perform conventional heat assisted air drying, heat must be provided by either hydrocarbon fuel sources or electrical heating sources. Heat assisted drying of harvest crops has numerous drawbacks, however. Two of the most prevalent drawbacks are high energy costs and heat damage to the harvest crops. The energy consumption of heat assisted drying in commercial agriculture, and even small scale agriculture, creates significant costs on a micro-scale and especially on a macro-scale. Further, heat damage is a significant issue within the agricultural harvest crops because of its high occurrence and impact on yield. Heat damages harvest crops by breaking/cracking, discoloring, and shrinking grains or kernels of the harvest crop.

In other industries, such as aggregate excavating, a large amount of aggregate material is removed from a mine or other source and requires drying. Conventionally, aggregate is dried using hydrocarbon based heaters. This method consumes large amounts of energy at a high cost. The cost of drying aggregate using hydrocarbon-based heating is even higher when the aggregate is being mined in a remote location and drying must occur before transportation because hydrocarbon fuel costs can increase dramatically in remote areas. Because aggregate drying typically does not have low heat restrictions, hydrocarbon based heating has been heavily used in the industry with minimal development in alternative methods of drying.

Ultimately, conventional methods for removing moisture or water from different materials are expensive and suffer from poor energy efficiencies. Systems that rely on spread-air type drying methods require large ventilated area, are weather dependent and time consuming. Similarly, heat-assisted drying systems are expensive, suffer from poor and uneven heating and, in the case of agricultural products, may cause heat damage to harvest crop, fruits and grains. Some recent methods employing electromagnetic radio-frequency fields are limited to low volumes, suffer from uneven drying and still cause some heat damage to the crop.

### SUMMARY

To address both the issues of high energy consumption and heat damage in harvest crop drying, an improved system and apparatus for drying harvest crops using radio frequency drying is disclosed. In particular, systems and methods of grain drying using radio frequency waves while maintaining low temperature is disclosed. Specifically, the use of radio frequencies falling on the lower end of heating type radio frequencies is disclosed, for example 13.56 MHz.

In one embodiment, a system and method for removing water from biomass and non-biomass material is directed to radio frequency wave propagation through targeted material. Specifically, the system and method includes minimizing temperature increases caused by dielectric radio frequency heating while increasing intermolecular hydrogen bond disruption.

In embodiments, a system for low end type radio frequency grain drying, e.g., 13.56 MHz, includes various apparatus for subjecting materials to electro-magnetic energy by using radio frequencies. The system includes a radio frequency generator capable of creating radio frequency electromagnetic waves around 13.56 MHz. Further, the system includes a receptacle for the biomass material. The receptacle can have any usable dimension. The receptacle can also be electrically conductive. The system also includes a plurality of metallic injectors. The metallic injectors are electrically coupled to the radio frequency generator through an automatic tuner. Further, the metallic injectors are in direct contact with the biomass in the receptacle. The metallic injectors can comprise copper, silver, or any other electrically conductive material. Further the metallic injectors can have titanium, iridium, or any other suitable coating. The metallic injectors can have various configurations including different numbers of metallic injectors in different orientations with respect to the receptacle.

The disclosure generally relates to moisture-removal systems, utilizing electromagnetic radio-frequency fields, including an assembly of electrical transmission lines, electromagnetic radio-frequency generators, cables, and related electrical components. In particular, the present disclosure provides an energy-efficient electromagnetic radio-frequency drying system that uses propagating transmission-line electromagnetic modes to remove moisture from a variety of materials at low temperatures with minimal heat damage to the materials.

In one aspect, the present disclosure provides a moisture-removal system that includes having spaced apart a first and a second electrical conductor extending along a same first direction, each of the first and the second electrical conductor comprising opposing broad top and bottom sides, the broad bottom side of the first electrical conductor facing the broad top side of the second electrical conductor; and a material containing moisture at least partially filling the space between the first and the second electrical conductor. The moisture-removal system further includes at least one first wire with a first and a second end, the first end of the first wire attached to a first radio frequency generator and the second end of the first wire attached to the first end of the first electrical conductor. The moisture-removal system further includes a common electrical grounding system, comprising at least one second wire with a first and a second end, with the first end of the second wire attached to the electrical ground of the first radio frequency generator and the second end of the second wire attached to the first end of the second electrical conductor.

In another aspect, the present disclosure provides a moisture-removal system that includes having spaced apart a first and a second electrical conductor extending along a same first direction, each of the first and second electrical conductor comprising opposing broad top and bottom sides, and each of the first and second electrical conductor having at least one hole extending from its broad top side to its broad bottom side; further the broad bottom side of the first electrical conductor facing the broad top side of the second electrical conductor; and a material containing moisture at least partially filling the space between the first and the second electrical conductor. The moisture-removal system further includes at least one first wire with a first and a second end, the first end of the first wire attached to a first radio frequency generator and the second end of the first wire attached to the first end of the first electrical conductor. The moisture-removal system further includes a common electrical grounding system, comprising at least one second wire with a first and a second end, with the first end of the second wire attached to the electrical ground of the first radio frequency generator and the second end of the second wire attached to the first end of the second electrical conductor. In another aspect, the present disclosure provides a moisture-removal system that includes having spaced apart a first and a second electrical conductor extending along a same first direction, each of the first and second electrical conductor comprising opposing broad top and bottom sides, the broad bottom side of the first electrical conductor facing the broad top side of the second electrical conductor; and a material containing moisture at least partially filling the space between the first and the second electrical conductor. The moisture-removal system further includes at least one first coaxial cable with a first and a second end, the first coaxial cable comprising a central conductor and an outer shield, the first end of the first coaxial cable is attached to a first radio frequency generator and the second end of the first coaxial cable is attached to the first and second electrical conductors such that the central conductor of the first coaxial cable is attached to the first end of the first electrical conductor and the outer shield of the first coaxial cable is attached to the first end of the second electrical conductor.

In another aspect, the present disclosure provides a moisture-removal system that includes having spaced apart a first and a second electrical conductor extending along a same first direction, each of the first and the second electrical conductor comprising opposing broad top and bottom sides, and each of the first and the second electrical conductor having at least one hole extending from its broad top side to its broad bottom side; further the broad bottom side of the first electrical conductor facing the broad top side of the second electrical conductor; and a material containing moisture at least partially filling the space between the first and the second electrical conductor. The moisture-removal system further includes at least one first coaxial cable with a first and a second end, the first coaxial cable comprising a central conductor and an outer shield, the first end of the first coaxial cable is attached to a first radio frequency generator and the second end of the first coaxial cable is attached to the first and the second electrical conductors such that the central conductor of the first coaxial cable is attached to the first end of the first electrical conductor and the outer shield of the first coaxial cable is attached to the first end of the second electrical conductor.

In another aspect, the present disclosure provides a moisture-removal system that includes having spaced apart a first and a second electrical conductor extending along a same first direction, each of the first and second electrical conductor comprising opposing broad top and bottom sides, the broad bottom side of the first electrical conductor facing the broad top side of the second electrical conductor; and a material containing moisture at least partially filling the space between the first and the second electrical conductor. The moisture-removal system further includes a first inductor-capacitor assembly, comprising at least one inductor and at least one capacitor, and having a first, a second and a third end. The moisture-removal system further includes at least one first wire with a first and a second end, the first end of the first wire attached to a first radio frequency generator and the second end of the first wire attached to the first end of the first inductor-capacitor assembly. The moisture-removal system further includes a common electrical grounding system, comprising at least one second wire with a first and a second end, the first end of the second wire attached to the electrical ground of the first radio frequency generator and the second end of the second wire attached to the third end of the first inductor-capacitor assembly. The moisture-removal system further includes at least a third and a fourth electrical wire, each with a first end and a second end, the first end of the third wire attached to the second end of the first inductor-capacitor assembly, and the second end of the third wire attached to the first end of the first electrical conductor. Further, the first end of the fourth wire is attached to the third end of the first inductor-capacitor assembly and the second end of the fourth wire is attached to the first end of the second electrical conductor.

In another aspect, the present disclosure provides a moisture-removal system that includes having spaced apart a first and a second electrical conductor extending along a same first direction, each of the first and the second electrical conductor comprising opposing broad top and bottom sides, and each of the first and second electrical conductor having at least one hole extending from its broad top side to its broad bottom side; further the broad bottom side of the first electrical conductor facing the broad top side of the second electrical conductor; and a material containing moisture at least partially filling the space between the first and the second electrical conductor. The moisture-removal system further includes a first inductor-capacitor assembly, comprising at least one inductor and at least one capacitor, and having a first, a second and a third end. The moisture-removal system further includes at least one first wire with a first and a second end, the first end of the first wire attached to a first radio frequency generator and the second end of the first wire attached to the first end of the first inductor-capacitor assembly. The moisture-removal system further includes a common electrical grounding system, comprising at least one second wire with a first and a second end, the first end of the second wire attached to the electrical ground of the first radio frequency generator and the second end of the second wire attached to the third end of the first inductor-capacitor assembly. The moisture-removal system further includes at least a third and a fourth electrical wire, each with a first end and a second end, the first end of the third wire attached to the second end of the first inductor-capacitor assembly, and the second end of the third wire attached to the first end of the first electrical conductor. Further, the first end of the fourth wire is attached to the third end of the first inductor-capacitor assembly and the second end of the fourth wire is attached to the first end of the second electrical conductor.

In another aspect, the present disclosure provides a moisture-removal system that includes having spaced apart a first and a second electrical conductor extending along a same first direction, each of the first and second electrical conductor comprising opposing broad top and bottom sides, the broad bottom side of the first electrical conductor facing the broad top side of the second electrical conductor; and a material containing moisture at least partially filling the space between the first and the second electrical conductor. The moisture-removal system further includes a first inductor-capacitor assembly, comprising at least one inductor and at least one capacitor, and having a first, a second and a third end. The moisture-removal system further includes at least a first and a second coaxial cable, each with a first and a second end; each of the first and the second coaxial cable comprising a central conductor and an outer shield. Further, the first end of the first coaxial cable is attached to a first radio frequency generator and the second end of the first coaxial cable is attached to the first inductor-capacitor assembly such that the central conductor of the first coaxial cable is attached to the first end of the first inductor-capacitor assembly and the outer shield of the first coaxial cable is attached to the third end of the first inductor-capacitor assembly. Similarly, the first end of the second coaxial cable is attached to the first inductor-capacitor assembly such that the central conductor of the second coaxial cable is attached to the second end of the inductor-capacitor assembly and the outer shield of the second coaxial cable is attached to the third end of the first inductor-capacitor assembly. Further, at the second end of the second coaxial cable, the central conductor of the second coaxial cable is attached to the first end of the first electrical conductor and the outer shield of the second coaxial cable is attached to the first end of the second electrical conductor.

In another aspect, the present disclosure provides a moisture-removal system that includes having spaced apart a first and a second electrical conductor extending along a same first direction, each of the first and second electrical conductor comprising opposing broad top and bottom sides, and each of the first and second electrical conductor having at least one hole extending from its broad top side to its broad bottom side; further the broad bottom side of the first electrical conductor facing the broad top side of the second electrical conductor; and a material containing moisture at least partially filling the space between the first and the second electrical conductor. The moisture-removal system further includes a first inductor-capacitor assembly, comprising at least one inductor and at least one capacitor, and having a first, a second and a third end. The moisture-removal system further includes at least a first and a second coaxial cable, each having a first and a second end; the first and the second coaxial cable each comprising a central conductor and an outer shield. Further, the first end of the first coaxial cable is attached to a first radio frequency generator and the second end of the first coaxial cable is attached to the first inductor-capacitor assembly such that the central conductor of the first coaxial cable is attached to the first end of the first inductor-capacitor assembly and the outer shield of the first coaxial cable is attached to the third end of the first inductor-capacitor assembly. Similarly, the first end of the second coaxial cable is attached to the first inductor-capacitor assembly such that the central conductor of the second coaxial cable is attached to the second end of the inductor-capacitor assembly and the outer shield of the second coaxial cable is attached to the third end of the first inductor-capacitor assembly. Further, at the second end of the second coaxial cable, the central conductor of the second coaxial cable is attached to the first end of the first electrical conductor and the outer shield of the second coaxial cable is attached to the first end of the second electrical conductor.

In yet another aspect, the present disclosure provides a moisture-removal system that includes having spaced apart a first, a second and a third electrical conductor extending along a same first direction, each of the first, the second and the third electrical conductor comprising opposing broad top and broad bottom sides, the broad bottom side of the first electrical conductor facing the broad top side of the second electrical conductor and the broad bottom side of the second electrical conductor facing the broad top side of the third electrical conductor; and a material containing moisture at least partially filling the space between the first and the second electrical conductor or between the second and the third electrical conductor. The moisture-removal system further includes at least one first wire with a first and a second end, the first end of the first wire attached to a first radio frequency generator and the second end of the first wire attached to the first end of the second electrical conductor. The moisture-removal system further includes a common electrical grounding system, comprising at least a second and a third wire, each having a first and a second end; the first end of the second wire and the first end of the third wire attached to the electrical ground of the first radio frequency generator, and the second end of the second wire attached to the first end of the first electrical conductor and the second end of the third wire attached to the first end of the third electrical conductor.

In yet another aspect, the present disclosure provides a moisture-removal system that includes having spaced apart a first, a second and a third electrical conductor extending along a same first direction; each of the first, the second and the third electrical conductor comprising opposing broad top and bottom sides, and each of the first, the second and the third electrical conductor having at least one hole extending from its broad top side to broad bottom side; the broad bottom side of the first electrical conductor facing the broad top side of the second electrical conductor and the broad bottom side of the second electrical conductor facing the broad top side of the third electrical conductor; and a material containing moisture at least partially filling the space between the first and the second electrical conductor or between the second and the third electrical conductor. The moisture-removal system further includes at least one first wire with a first end and a second end, the first end of the first wire attached to a first radio frequency generator and the second end of the first wire attached to the first end of the second electrical conductor. The moisture-removal system further includes a common electrical grounding system, comprising at least a second and a third wire, each having a first end and a second end; the first end of the second wire and the first end of the third wire attached to the electrical ground of the first radio frequency generator and the second end of the second wire attached to the first end of the first electrical conductor and the second end of the third wire attached to the first end of the third electrical conductor.

In yet another aspect, the present disclosure provides a moisture-removal system that includes a first assembly of electrical conductors comprising having spaced apart a first, a second and a third electrical conductor extending along a same first direction; each of the first, the second and the third electrical conductor comprising opposing broad top and bottom sides; the broad bottom side of the first electrical conductor facing the broad top side of the second electrical conductor and the broad bottom side of the second electrical conductor facing the broad top side of the third electrical conductor; and a material containing moisture at least partially filling the space between the first and the second electrical conductor or between the second and the third electrical conductor. The moisture-removal system further includes at least one first coaxial cable with a first end and a second end, the first coaxial cable comprising a central conductor and an outer shield; the first end of the first coaxial cable attached to a first radio frequency generator and the second end of the first coaxial cable is attached to the first assembly of the electrical conductors such that the central conductor of the first coaxial cable is attached to the first end of the second electrical conductor and the outer shield of the first coaxial cable is attached to the first end of the first electrical conductor and the first end of the third electrical conductor via at least one electrical wire.

In yet another aspect, the present disclosure provides a moisture-removal system that includes a first assembly of electrical conductors comprising having spaced apart a first, a second and a third electrical conductor extending along a same first direction; each of the first, the second and the third electrical conductor having at least one hole extending from its broad top side to broad bottom side; and each of the first, the second and the third electrical conductor comprising opposing broad top and bottom sides, the broad bottom side of the first electrical conductor facing the broad top side of the second electrical conductor and the broad bottom side of the second electrical conductor facing the broad top side of the third electrical conductor; and a material containing moisture at least partially filling the space between the first and the second electrical conductor or between the second and the third electrical conductor. The moisture-removal system further includes at least one first coaxial cable, having a first end and a second end, and comprising a central conductor and an outer shield; the first end of the first coaxial cable attached to a first radio frequency generator and the second end of the first coaxial cable is attached to the first assembly of the electrical conductors such that the central conductor of the first coaxial cable is attached to the first end of the second electrical conductor and the outer shield of the first coaxial cable is attached to the first end of the first electrical conductor and the first end of the third electrical conductor via at least one electrical wire.

In yet another aspect, the present disclosure provides a moisture-removal system that includes a first assembly of electrical conductors comprising having spaced apart a first, a second and a third electrical conductor extending along a same first direction, and each conductor comprising opposing broad top and broad bottom sides; the broad bottom side of the first electrical conductor facing the broad top side of the second electrical conductor and the broad bottom side of the second electrical conductor facing the broad top side of the third electrical conductor; and a material containing moisture at least partially filling the space between the first and the second electrical conductor or between the second and the third electrical conductor. The moisture-removal system further includes a first inductor-capacitor assembly, comprising at least one inductor and at least one capacitor, and having a first, a second and a third end. The moisture-removal system further includes at least one first wire with a first end and a second end, the first end of the first wire attached to a first radio frequency generator and the second end of the first wire attached to the first end of the first inductor-capacitor assembly. The moisture-removal system further includes a common electrical grounding system, comprising at least one second wire with a first end and a second end, with the first end of the second wire attached to the electrical ground of the first radio frequency generator and the second end of the second wire attached to the third end of the first inductor-capacitor assembly. The moisture-removal system further includes at least a third, a fourth and a fifth electrical wire, each having a first end and a second end; the first end of the third wire attached to the second end of the first inductor-capacitor assembly and the second end of the third wire is attached to the first end of the second electrical conductor. Further, the first end of the fourth wire is attached to the third end of the first inductor-capacitor assembly and the second end of the fourth wire is attached to the first end of the first electrical conductor. Similarly, the first end of the fifth wire is attached to the third end of the first inductor-capacitor assembly and the second end of the fifth wire is attached to the first end of the third electrical conductor.

In yet another aspect, the present disclosure provides a moisture-removal system that includes a first assembly of electrical conductors comprising having spaced apart a first, a second and a third electrical conductor extending along a same first direction, and each conductor comprising opposing broad top and bottom sides, and each of the first, the second and the third electrical conductor having at least one hole extending from its broad top side to broad bottom side; the broad bottom side of the first electrical conductor facing the broad top side of the second electrical conductor and the broad bottom side of the second electrical conductor facing the broad top side of the third electrical conductor; and a material containing moisture at least partially filling the space between the first and the second electrical conductor or between the second and the third electrical conductor. The moisture-removal system further includes a first inductor-capacitor assembly, comprising at least one inductor and at least one capacitor, and having a first, a second and a third end. The moisture-removal system further includes at least one first wire with a first end and a second end, the first end of the first wire attached to a first radio frequency generator and the second end of the first wire attached to the first end of the first inductor-capacitor assembly. The moisture-removal system further includes a common electrical grounding system, comprising at least one second wire with a first end and a second end, the first end of the second wire attached to the electrical ground of the first radio frequency generator and the second end of the second wire attached to the third end of the first inductor-capacitor assembly. The moisture-removal system further includes at least a third, a fourth and a fifth electrical wire, each having a first end and a second end, the first end of the third wire attached to the second end of the first inductor-capacitor assembly, and the second end of the third wire is attached to the first end of the second electrical conductor. Further, the first end of the fourth wire is attached to the third end of the first inductor-capacitor assembly and the second end of the fourth wire is attached to the first end of the first electrical conductor. Similarly, the first end of the fifth wire is attached to the third end of the first inductor-capacitor assembly and the second end of the fifth wire is attached to the first end of the third electrical conductor.

In yet another aspect, the present disclosure provides a moisture-removal system that includes a first assembly of electrical conductors comprising having spaced apart a first, a second and a third electrical conductor, extending along a same first direction; each conductor of the first assembly comprising opposing broad top and broad bottom sides such that the broad bottom side of the first electrical conductor facing the broad top side of the second electrical conductor and the broad bottom side of the second electrical conductor facing the broad top side of the third electrical conductor; and a material containing moisture at least partially filling the space between the first and the second electrical conductor or between the second and the third electrical conductor. The moisture-removal system further includes a first inductor-capacitor assembly, comprising at least one inductor and one capacitor and having a first, a second and a third end. The moisture-removal system further includes at least a first and a second coaxial cable, each having a first end and a second end, and each cable comprising a central conductor and an outer shield. Further, the first end of the first coaxial cable is attached to a first radio frequency generator and the second end of the first coaxial cable attached to the first inductor-capacitor assembly such that the central conductor of the first coaxial cable is attached to the first end of the inductor-capacitor assembly and the outer shield of the first coaxial cable is attached to the third end of the first inductor-capacitor assembly. Similarly, the first end of the second coaxial cable is attached to the first inductor-capacitor assembly such that the central conductor of the second coaxial cable is attached to the second end of the first inductor-capacitor assembly and the outer shield of the second coaxial cable is attached to the third end of the first inductor-capacitor assembly. Further, at the second end of the second coaxial cable, the central conductor of the second coaxial cable is attached to the first end of the second electrical conductor and the outer shield of the second coaxial cable is attached to the first end of the first electrical conductor and to the first end of the third electrical conductor via at least one wire.

In yet another aspect, the present disclosure provides a moisture-removal system that includes a first assembly of electrical conductors comprising having spaced apart a first, a second and a third electrical conductor, each extending along a same first direction and each comprising opposing broad top and broad bottom sides; each of the first, the second and the third electrical conductor having at least one hole extending from its broad top side to its broad bottom side; the broad bottom side of the first electrical conductor facing the broad top side of the second electrical conductor and the broad bottom side of the second electrical conductor facing the broad top side of the third electrical conductor; and a material containing moisture at least partially filling the space between the first and the second electrical conductor or between the second and the third electrical conductor. The moisture-removal system further includes a first inductor-capacitor assembly comprising at least one inductor and one capacitor and having a first end, a second end and a third end. The moisture-removal system further includes at least a first and a second coaxial cable, each having a first end and a second end and each coaxial cable comprising a central conductor and an outer shield. Further, the first end of the first coaxial cable is attached to a first radio frequency generator and the second end of the first coaxial cable attached to the first inductor-capacitor assembly such that the central conductor of the first coaxial cable is attached to the first end of the inductor-capacitor assembly and the outer shield of the first coaxial cable is attached to the third end of the first inductor-capacitor assembly. Similarly, the first end of the second coaxial cable is attached to the first inductor-capacitor assembly such that the central conductor of the second coaxial cable is attached to the second end of the first inductor-capacitor assembly and the outer shield of the second coaxial cable is attached to the third end of the first inductor-capacitor assembly. Further, at the second end of the second coaxial cable, the central conductor of the second coaxial cable is attached to the first end of the second electrical conductor and the outer shield of the second coaxial cable is attached to the first end of the first electrical conductor and to the first end of the third electrical conductor via at least one wire.

In yet another aspect, the present disclosure provides a moisture-removal system that includes a first assembly of having spaced apart a first, a second and a third electrical conductor, each having a first and a second end and each extending along a same first direction; each conductor of the first assembly comprising opposing broad top and broad bottom sides such that the broad bottom side of the first electrical conductor facing the broad top side of the second electrical conductor and the broad bottom side of the second electrical conductor facing the broad top side of the third electrical conductor; and a material containing moisture at least partially filling the space between the first and the second electrical conductor or the space between the second and the third electrical conductor. The moisture-removal system further includes a second assembly of having spaced apart a fourth, a fifth and a sixth electrical conductor, each with a first and a second end, and each extending along the same first direction; each conductor of the second assembly comprising opposing broad top and bottom sides and opposing narrow edges; the broad bottom side of the fourth electrical conductor facing the broad top side of the fifth electrical conductor and the broad bottom side of the fifth electrical conductor facing the broad top side of the sixth electrical conductor; the distance between the narrow edges of each conductor of the second assembly gradually increases from their first ends to their second ends such that the second end of the fourth conductor is as wide as the first end of the first conductor, the second end of the fifth conductor is as wide as the first end of the second conductor and the second end of the sixth conductor is as wide as the first end of the third electrical conductor. Similarly, the spacing between the fourth, fifth and sixth electrical conductors gradually increasing from their first ends to their second ends such that the second end of the fourth electrical conductor touching the first end of the first electrical conductor, the second end of the fifth electrical conductor touching the first end of the second electrical conductor and the second end of the sixth electrical conductor touching the first end of the third electrical conductor. Similarly, the distance between the opposing narrow edges of each of the fourth, fifth and the sixth electrical conductors and the spacing between the fourth, fifth and the sixth electrical conductors at their first ends are of the order that a first coaxial connector of a suitable size can be mounted on the second assembly with the outer ground of the first coaxial connector touching the fourth and the sixth electrical conductors and the center pin of the first coaxial connector touching the fifth electrical conductor. Further, the moisture-removal system includes at least one first coaxial cable, having a first end and a second end, and comprising a central conductor and an outer shield; the first end of the coaxial cable is attached to a first radio frequency generator and the second end of the first coaxial cable is attached to the first coaxial connector.

In yet another aspect, the present disclosure provides a moisture-removal system that includes a first assembly of having spaced apart a first, a second and a third electrical conductor, each having a first and a second end and each extending along a same first direction; each conductor of the first assembly comprising opposing broad top and broad bottom sides such that the broad bottom side of the first electrical conductor facing the broad top side of the second electrical conductor and the broad bottom side of the second electrical conductor facing the broad top side of the third electrical conductor; and each conductor of the first assembly having at least one hole extending from its broad top side to broad bottom side; and a material containing moisture at least partially filling the space between the first and the second electrical conductor or the space between the second and the third electrical conductor. The moisture-removal system further includes a second assembly of having spaced apart a fourth, a fifth and a sixth electrical conductor, each with a first and a second end, and each extending along the same first direction; each conductor of the second assembly comprising opposing broad top and bottom sides and opposing narrow edges; the broad bottom side of the fourth electrical conductor facing the broad top side of the fifth electrical conductor and the broad bottom side of the fifth electrical conductor facing the broad top side of the sixth electrical conductor; the distance between the narrow edges of each conductor of the second assembly gradually increases from their first ends to their second ends such that the second end of the fourth conductor is as wide as the first end of the first conductor, the second end of the fifth conductor is as wide as the first end of the second conductor and the second end of the sixth conductor is as wide as the first end of the third electrical conductor. Similarly, the spacing between the fourth, fifth and sixth electrical conductors gradually increasing from their first ends to their second ends such that the second end of the fourth electrical conductor touching the first end of the first electrical conductor, the second end of the fifth electrical conductor touching the first end of the second electrical conductor and the second end of the sixth electrical conductor touching the first end of the third electrical conductor. Similarly, the distance between the opposing narrow edges of each of the fourth, fifth and the sixth electrical conductors and the spacing between the fourth, fifth and the sixth electrical conductors at their first ends are of the order that a first coaxial connector of a suitable size can be mounted on the second assembly with the outer ground of the first coaxial connector touching the fourth and the sixth electrical conductors and the center pin of the first coaxial connector touching the fifth electrical conductor. Further, the moisture-removal system includes at least one first coaxial cable, having a first end and a second end, and comprising a central conductor and an outer shield; the first end of the coaxial cable is attached to a first radio frequency generator and the second end of the first coaxial cable is attached to the first coaxial connector.

In yet another aspect, the present disclosure provides a moisture-removal system that includes a first assembly of having spaced apart a first, a second and a third electrical conductor, each having a first and a second end and each extending along a same first direction; each conductor of the first assembly comprising opposing broad top and bottom sides and narrow edges, with the broad bottom side of the first electrical conductor facing the broad top side of the second electrical conductor and the broad bottom side of the second electrical conductor facing the broad top side of the third electrical conductor; and a material containing moisture at least partially filling the space between the first and the second electrical conductor or the space between the second and the third electrical conductor. The moisture-removal system further includes a second assembly of having spaced apart a fourth, a fifth and a sixth electrical conductor, each with a first and a second end, and each extending along the same first direction; each conductor of the second assembly comprising opposing broad top and bottom sides and opposing narrow edges; the broad bottom side of the fourth electrical conductor facing the broad top side of the fifth electrical conductor and the broad bottom side of the fifth electrical conductor facing the broad top side of the sixth electrical conductor; the distance between the narrow edges of each conductor of the second assembly gradually increases from their first ends to their second ends such that the second end of the fourth conductor is as wide as the first end of the first conductor, the second end of the fifth conductor is as wide as the first end of the second conductor and the second end of the sixth conductor is as wide as the first end of the third electrical conductor. Similarly, the spacing between the fourth, fifth and sixth electrical conductors gradually increasing from their first ends to their second ends such that the second end of the fourth electrical conductor touching the first end of the first electrical conductor, the second end of the fifth electrical conductor touching the first end of the second electrical conductor and the second end of the sixth electrical conductor touching the first end of the third electrical conductor. Similarly, the distance between the opposing narrow edges of each of the fourth, fifth and the sixth electrical conductors and the spacing between the fourth, fifth and the sixth electrical conductors at their first ends are of the order that a first coaxial connector of a suitable size can be mounted on the second assembly with the outer ground of the first coaxial connector touching the fourth and the sixth electrical conductors and the center pin of the first coaxial connector touching the fifth electrical conductor. Further, the moisture-removal system includes at least one first coaxial cable, having a first end and a second end, and comprising a central conductor and an outer shield; the first end of the coaxial cable is attached to a first radio frequency generator and the second end of the first coaxial cable is attached to the first coaxial connector. The moisture-removal system further includes a third assembly of having spaced apart a seventh, an eighth and a ninth electrical conductor, each with a first and a second end, and each extending along the same first direction; each conductor of the third assembly comprising opposing broad top and bottom sides and opposing narrow edges; the broad bottom side of the seventh electrical conductor facing the broad top side of the eighth electrical conductor and the broad bottom side of the eighth electrical conductor facing the broad top side of the ninth electrical conductor; the distance between the narrow edges of each conductor of the third assembly gradually decreasing from their first ends to their second ends such that the first end of the seventh conductor is as wide as the second end of the first conductor, the first end of the eighth conductor is as wide as the second end of the second conductor and the first end of the ninth conductor is as wide as the second end of the third electrical conductor. Similarly, the spacing between the seventh, eighth and ninth electrical conductors gradually decreasing from their first ends to their second ends such that the first end of the seventh electrical conductor touching the second end of the first electrical conductor, the first end of the eighth electrical conductor touching the second end of the second electrical conductor and the first end of the sixth electrical conductor touching the second end of the third electrical conductor. Similarly, the distance between the opposing narrow edges of each of the seventh, eighth and ninth electrical conductors and the spacing between them at their second ends are of the order that a second coaxial connector of a suitable size can be mounted on the third assembly with the outer ground of the second coaxial connector touching the seventh and ninth electrical conductors and the center pin of the second coaxial connector touching the ninth electrical conductor. Further, the moisture-removal system includes at least one 50 ohm coaxial termination connected to the second coaxial connector.

In yet another aspect, the present disclosure provides a moisture-removal system that includes a first assembly of having spaced apart a first, a second and a third electrical conductor, each having a first and a second end and each extending along a same first direction; each conductor of the first assembly comprising opposing broad top and bottom sides and narrow edges, with the broad bottom side of the first electrical conductor facing the broad top side of the second electrical conductor and the broad bottom side of the second electrical conductor facing the broad top side of the third electrical conductor; and each conductor of the first assembly having at least one hole extending from its broad top side to broad bottom side; and a material containing moisture at least partially filling the space between the first and the second electrical conductor or the space between the second and the third electrical conductor. The moisture-removal system further includes a second assembly of having spaced apart a fourth, a fifth and a sixth electrical conductor, each with a first and a second end, and each extending along the same first direction; each conductor of the second assembly comprising opposing broad top and bottom sides and opposing narrow edges; the broad bottom side of the fourth electrical conductor facing the broad top side of the fifth electrical conductor and the broad bottom side of the fifth electrical conductor facing the broad top side of the sixth electrical conductor; the distance between the narrow edges of each conductor of the second assembly gradually increases from their first ends to their second ends such that the second end of the fourth conductor is as wide as the first end of the first conductor, the second end of the fifth conductor is as wide as the first end of the second conductor and the second end of the sixth conductor is as wide as the first end of the third electrical conductor. Similarly, the spacing between the fourth, fifth and sixth electrical conductors gradually increasing from their first ends to their second ends such that the second end of the fourth electrical conductor touching the first end of the first electrical conductor, the second end of the fifth electrical conductor touching the first end of the second electrical conductor and the second end of the sixth electrical conductor touching the first end of the third electrical conductor. Similarly, the distance between the opposing narrow edges of each of the fourth, fifth and the sixth electrical conductors and the spacing between the fourth, fifth and the sixth electrical conductors at their first ends are of the order that a first coaxial connector of a suitable size can be mounted on the second assembly with the outer ground of the first coaxial connector touching the fourth and the sixth electrical conductors and the center pin of the first coaxial connector touching the fifth electrical conductor. Further, the moisture-removal system includes at least one first coaxial cable, having a first end and a second end, and comprising a central conductor and an outer shield; the first end of the coaxial cable is attached to a first radio frequency generator and the second end of the first coaxial cable is attached to the first coaxial connector. The moisture-removal system further includes a third assembly of having spaced apart a seventh, an eighth and a ninth electrical conductor, each with a first and a second end, and each extending along the same first direction; each conductor of the third assembly comprising opposing broad top and bottom sides and opposing narrow edges; the broad bottom side of the seventh electrical conductor facing the broad top side of the eighth electrical conductor and the broad bottom side of the eighth electrical conductor facing the broad top side of the ninth electrical conductor; the distance between the narrow edges of each conductor of the third assembly gradually decreasing from their first ends to their second ends such that the first end of the seventh conductor is as wide as the second end of the first conductor, the first end of the eighth conductor is as wide as the second end of the second conductor and the first end of the ninth conductor is as wide as the second end of the third electrical conductor. Similarly, the spacing between the seventh, eighth and ninth electrical conductors gradually decreasing from their first ends to their second ends such that the first end of the seventh electrical conductor touching the second end of the first electrical conductor, the first end of the eighth electrical conductor touching the second end of the second electrical conductor and the first end of the sixth electrical conductor touching the second end of the third electrical conductor. Similarly, the distance between the opposing narrow edges of each of the seventh, eighth and ninth electrical conductors and the spacing between them at their second ends are of the order that a second coaxial connector of a suitable size can be mounted on the third assembly with the outer ground of the second coaxial connector touching the seventh and ninth electrical conductors and the center pin of the second coaxial connector touching the ninth electrical conductor. Further, the moisture-removal system includes at least one 50-ohm coaxial termination connected to the second coaxial connector.

In yet another aspect, the present disclosure provides a moisture-removal system that includes a first assembly of electrical conductors, each extending along a same first direction with each conductor having a first and a second end and each comprising opposing broad top and bottom sides and opposing first and second narrow edges; the conductors of the first assembly are arranged in a same second direction such that the second narrow edge of the first electrical conductor facing the first narrow edge of the second electrical conductor and the second narrow edge of the second electrical conductor facing the first narrow edge of the third electrical conductor and so on; and a first conducting platform having a length not smaller than any of the conductor of the first assembly and a width not smaller than the distance from the first narrow edge of the first electrical conductor to the second narrow edge of the last electrical conductor of the first assembly; the first assembly of the electrical conductors placed above the first conducting platform such that the broad bottom side of each conductor of the first assembly facing the conducting platform; and a material containing moisture at least partially filling the space between the first assembly of the electrical conductors and the first conducting platform. Further, the first conducting platform comprises moving plates or rails that can push the material containing moisture along the second direction. The moisture-removal system further includes a plurality of electric cables and wires that connect the first end of each conductor of the first assembly to a first radio frequency power source and the first conducting platform to the common electrical ground of the same first radio frequency power source.

In yet another aspect, the present disclosure provides a moisture-removal system that includes a first assembly of electrical conductors, each extending along a same first direction with each conductor having a first and a second end and each comprising opposing broad top and bottom sides and opposing first and second narrow edges, and each conductor having at least one hole from its broad bottom side to its broad top side; the conductors of the first assembly are arranged in a same second direction such that the second narrow edge of the first conductor facing the first narrow edge of the second electrical conductor and the second narrow edge of the second electrical conductor facing the first narrow edge of the third electrical conductor and so on; and a first conducting platform having a length not smaller than any of the conductor of the first assembly and a width not smaller than the distance from the first narrow edge of the first electrical conductor to the second narrow edge of the last electrical conductor of the first assembly; the first assembly of the electrical conductors placed above the first conducting platform such that the broad bottom side of each conductor of the first assembly facing the first conducting platform; and a material containing moisture at least partially filling the space between the first assembly of the electrical conductors and the first conducting platform. Further, the first conducting platform comprises moving plates or rails that can push the material containing moisture along the second direction. The moisture-removal system further includes a plurality of electric cables and wires that connect the first end of each conductor of the first assembly to a first radio frequency power source and the first conducting platform to the common electrical ground of the same first radio frequency power source.

In yet another aspect, the present disclosure provides a continuous flow radio frequency container dryer that dries agricultural biomass material. In embodiments, the container dryer is divided into different zones with each zone set to receive material at a specific moisture content. In an example embodiment, the container dryer is divided into eight different zones. Each zone contains a pair of parallel plates with one plate being a hot conductor, or emitter, and the other plate being a ground plate. A voltage potential difference is created between the plates to induce electrical field coupling into the material which induces ionic migration and dipole rotation which in-turn results in water release. Each zone is fed by a radio frequency (RF) source with an automatic matching network between them. The auto-match facilitates maximum power transfer from the RF source to the capacitor plates. The flow of material is facilitated by a push-pull metallic floor which also acts as the grounding structure for the RF return current. The container dryer can be divided into two shipping containers that house four zones each. The emitter plates are controlled by a hydraulic system, such that the container dryer can handle material of varying thicknesses. A fan on the side of the dryer is powering a plenum with uniform airflow going into the material. In embodiments, the fan can be a 2-horsepower fan. The high humidity air from the material is vacuumed out of the dryer by an outlet fan on each floor of the dryer. The RF can be assisted with hot air sourced from a propane tank which is kept at the inlet of the fan to maintain an even bed temperature. Combining a convective drying system with the RF has an upward effect on the drying rate of the system.

In yet another aspect, the present disclosure provides a radio frequency based cylindrical dryer that dries granular agricultural material. The material, which is commonly grain, is fed from the top of the cylindrical dryer using an auger system. The cylindrical architecture of the cylindrical dryer enables the dryer to hold a larger volume. In embodiments, such a cylindrical dryer can be divided height-wise into at least two zones. Each zone can contain at least one circular plate. A cylindrical dryer having two zones and three circular plates bent circularly would create a 5-plate parallel plate capacitor configuration. The input power coming from the RF source is split between two emitter sections which induce a voltage potential difference between the plates which capacitively couple electrical fields into the granular material. This coupling of fields into the material causes ionic migration and dipole rotation that in turn cause water migration to the outside of the material. Each zone has a matching network present to maximize power transfer to the emitter plates. The dryer has a conical air plenum which is sourced by a fan which uniformly blows the air into the material to get the moisture out of the system. In embodiments, the fan can be a 2-horsepower fan.

In yet another aspect, the present disclosure provides a length-cuboid radio frequency based dryer used to dry agricultural biomass material. The material to be dried, ranging in thickness from 6 inches to 2 feet, is placed in between two plates. The geometry of the length-cuboid dryer body is a cuboid with the length of the dryer as the dominant dimension. One plate acts as the hot conductor, or emitter, and the other as a ground plate. Two RF sources are used to power the dryer from either end. Each source is connected to a match network which facilitates maximum power transfer to the material. To get an efficient heating pattern, both of the RF sources share the same emitter and ground plates. The generators operate at an alternating time pulse, so any kind of interference is mitigated. The coupling of RF energy to the material instigates ionic migration and dipolar rotation which breaks the intra molecular water bonds. A fan is placed on either sides of the length-cuboid dryer in the air chamber to vacuum out high humidity air from the heating bed. In embodiments, the fan can be a 2-horsepower fan.

In yet another aspect, the present disclosure provides a radio frequency based height-cuboid dryer used to dry granular agricultural material. The geometry of the height-cuboid dryer is cuboid based which the height being the dominant dimension. The material to be dried is fed from the top of the dryer. The height-cuboid dryer is divided into different zones which dry material based on the moisture content of the incoming material. The residency time of the dryer is adjusted such that each zone receives grains with a set moisture content. Each zone consists of a series of at least five plates which is powered by an RF source. These plates capacitively couple RF energy to the grain which induces ionic migration and dipole rotation responsible for the breakage of the O—H bond between water molecules. An automatic matching network is placed between the RF source and the emitter plates that facilitates maximum power transfer from the RF source to the capacitor. A voltage potential difference is created between these plates which is absorbed by the granular material. The power density going into the material can be adjusted by changing the plate surface area or by changing the distance between the plates. The height-cuboid dryer follows a continuous flow mechanism with wet grain fed from the top and dry grain received at the bottom. A fan is used to pressurize a plenum which uniformly distributes airflow throughout the granular material which removes the water released from the effects of radio frequency coupling. In embodiments, the fan can be a 250-horsepower fan.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1A-B is a front partially transparent view of a grain drying system, according to embodiments.

FIG. 2 is a schematic view of a metallic injector, according to embodiments.

FIG. 3 is a diagram view of a radio frequency de-bonding system, according to embodiments.

FIG. 4 is an isometric view of an alternative embodiment of a drying system, according to embodiments.

FIG. 5A is one embodiment of the moisture-removal system that includes two electrical conductor and an RF generator.

FIG. 5B is a cross-sectional view of the embodiment illustrated in FIG. 5A;

FIG. 5C is yet another illustration of the moisture-removal system of FIG. 5A that also includes a matching network.

FIG. 6A is another embodiment of the moisture-removal system that includes three electrical conductors.

FIG. 6B is a cross-sectional view of the embodiment illustrated in FIG. 6A.

FIG. 6C is a top view of the embodiment illustrated in FIG. 6A.

FIG. 7A is a side view of a two plate design moisture-removal system, according to an embodiment.

FIG. 7B is a cross-sectional view of the embodiment illustrated in FIG. 7A.

FIG. 8 is a diagram of the match network connections for a two plate design moisture-removal system, according to an embodiment.

FIG. 9A is an overhead cross-sectional view of a five plate cylindrical design moisture-removal system, according to an embodiment.

FIG. 9 B is a side view of the embodiment illustrated in FIG. 9A.

FIG. 10 is a diagram of the match network connections for a five plate design moisture-removal system, according to an embodiment.

FIG. 11 is a side view of a two plate design moisture-removal system, according to an embodiment.

FIG. 12 is a side view and a magnified view of a match network connection for a two plate design moisture-removal system, according to an embodiment.

FIG. 13 is an overhead view and a magnified view of a vertical five plate design moisture-removal system, according to an embodiment.

FIG. 14A-B is a side view of the embodiment illustrated in FIG. 13.

FIG. 15 is an overhead view and a magnified view of match network connections of a vertical five plate design moisture-removal system, according to an embodiment.

FIG. 16 is a block diagram of a RF switch system, according to an embodiment.

FIG. 17 is a diagram of a RF switch system, according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

The present disclosure provides a new method for removing moisture from a variety of materials including agricultural biomass products (harvest crop, fruit, grains etc.), manure, human waste, construction aggregate materials, wet sand etc. For this purpose, the disclosed moisture-removal systems employ electromagnetic radio frequency power. However, unlike conventional electromagnetic radio frequency drying techniques that rely on high-power dielectric heating of material-moisture mixtures, the disclosed systems employ propagating transverse electromagnetic modes through a material to break its hydrogen bond with water and push the moisture content out of the material using gravity or forced air. Since the disclosed moisture-removal systems do not remove water from a material by evaporation, the drying can occur at low temperatures and any heat damage to the material can be avoided.

In the following description, drawings are provided and referred for the sake of illustration only. Other embodiments can be contemplated and made without departing from the scope or spirit of the present disclosure. As such, the following description should not be taken in a limiting sense. The illustrations, descriptions and language used to describe these do not limit the present disclosure

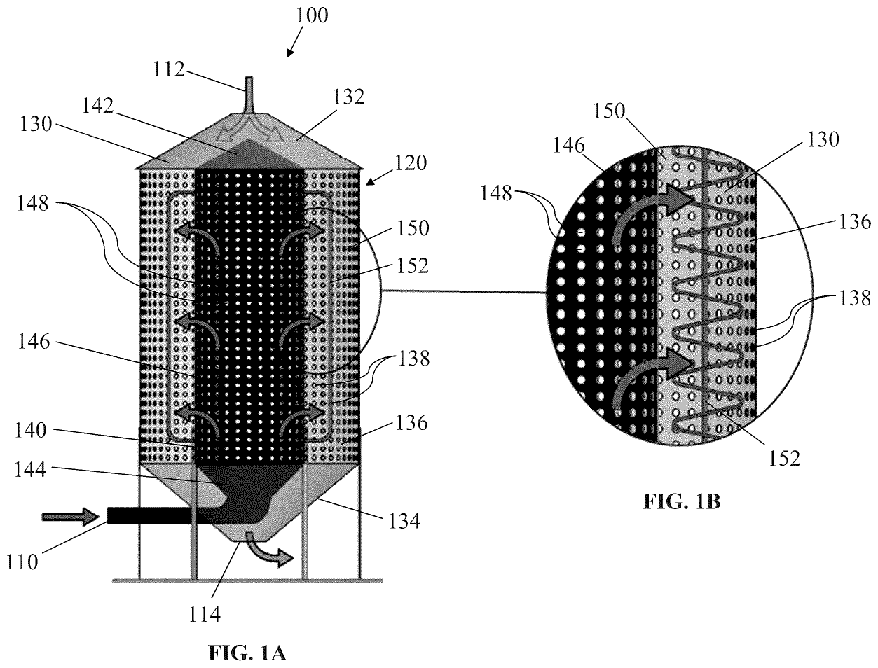

Systems and methods of grain drying using radio frequency waves while maintaining low temperature are disclosed herein. The method and systems depicted in FIGS. 1-3 serve to illustrate the use of radio frequency waves to dry harvest crops at low temperatures.

Specifically, the system and method includes minimizing temperature increases caused by dielectric radio frequency heating while increasing intermolecular hydrogen bond disruption.

In one embodiment and referring to FIG. 1a-b, a grain drying system 100 includes an air inlet 110, a grain entrance 112, a grain exit 114, and a housing 120. In embodiments, housing 120 includes an exterior receptacle 130. Exterior receptacle 130 can include an exterior top 132, exterior bottom 134, and an exterior cylindrical face 136. Further, exterior receptacle 130 can be electrically conductive. Exterior cylindrical face 136 also can include a plurality of apertures 138 for use in air ventilation. In embodiments, housing 120 includes an interior receptacle 140. Interior receptacle 140 can include an interior top 142, interior bottom 144, and an interior cylindrical face 146. Further, interior receptacle 140 can be electrically conductive. Interior cylindrical face 146 also can include a plurality of apertures 148 for use in air ventilation. In embodiments, exterior receptacle 130 is larger than interior receptacle 140.

As depicted in FIG. 1a, exterior receptacle 130 and interior receptacle 140 can be arranged coaxially such that interior receptacle 140 is arranged within exterior receptacle 130. In such arrangement, a cavity 150 is created wherein the biomass or non-biomass material can be placed. Within cavity 150, a metallic injector 152 can be arranged such that it is electrically isolated from exterior receptacle 130 and interior receptacle 140, yet makes intimate contact with the biomass or non-biomass material. Further, an airflow path is created in this arrangement such that forced air can enter internal receptacle 140 via air entrance 110, then, and referring to FIG. 1B, can travel through apertures 148, through the biomass and non-biomass material within cavity 150, and then exit external receptacle 130 via apertures 138.

In this embodiment, radio frequency electromagnetic waves transmitted from metallic injector 152 can travel through the biomass and non-biomass in cavity 150. Further, radio frequency waves are shielded from exiting external receptacle 130 due to its metallic nature. This arrangement also serves to create a moisture sensing ability by correlating the changing impedance of the biomass to changing moisture content based on the type of biomass during a drying cycle.

For example, the complex impedance (Z) of grain drying system 100 can be modeled by the following equation:

$$\vert Z \vert = \sqrt{{R}^{2} + {( ω L - \frac{1}{ω C} )}^{2}}$$

Where R is the resistance, L is the inductance, C is the capacitance, and w is the frequency. To approximate the capacitance C of the biomass in grain drying system 100 and with respect to interior receptacle 140 and/or exterior receptacle 130, the equation for a cylindrical capacitor can be used as a basis. For example:

$$C = \frac{2 {πε}_{r} {ε}_{0} ( length )}{ln ( \frac{a}{b} )}$$

Where a is an inner radius, b is an outer radius, and length is the length of the cylinder. Further, ε₀ is the permittivity and εᵣ is the relative permittivity of the biomass. Because moisture content of the biomass affects the relative permittivity, εᵣ, of the biomass, moisture content can be derived through active tuning of the system. Further, resistance, R, and Inductance, L, are also affected by moisture content and can therefore also be manipulated to show moisture content. For example, moisture content can be derived from tuning if the system is tuned to find the best return loss value of the electromagnetic wave power, which can be equated to a mismatch in complex impedance.

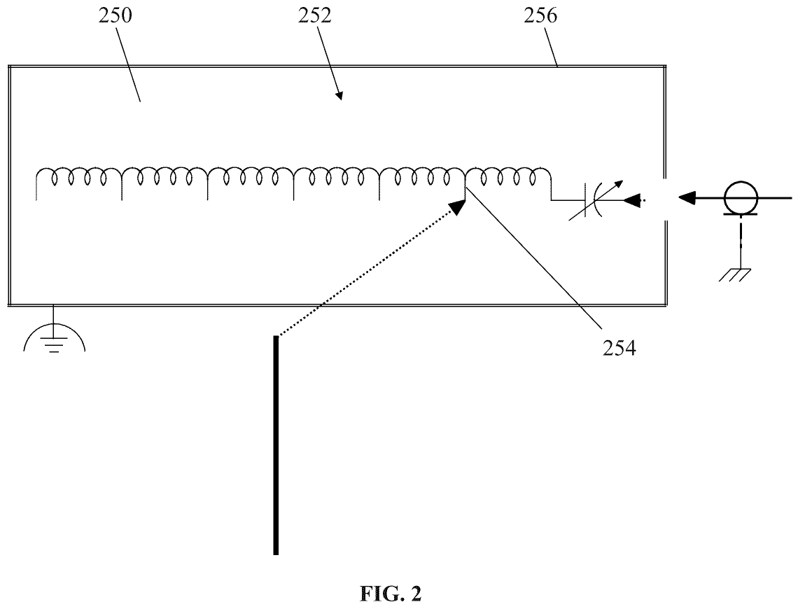

FIG. 2 depicts a diagram of the biomass and non-biomass cavity 250 which includes a metallic injector 252. In embodiments metallic injector 252 includes the injector rod 254. Surrounding, cavity 250 is receptacle 256. In embodiments, receptacle 256 electrically models what would be exterior receptacle 130 and/or interior receptacle 140 of grain drying system 100 as previously described. Injector rod 254 serves to transmit radio frequency electromagnetic waves to its surroundings. Injector rod 254 can be made of copper, silver, or any other electrically conductive material. Further, injector rod 254 can have titanium, iridium, or any other suitable coating. The titanium, or other coating, serves to protect metallic injector 252 from corrosion and further supports surface maintenance. Receptacle 256, which is electrically grounded, acts as a Faraday shield for the system and isolates the radio frequency waves to cavity 250.

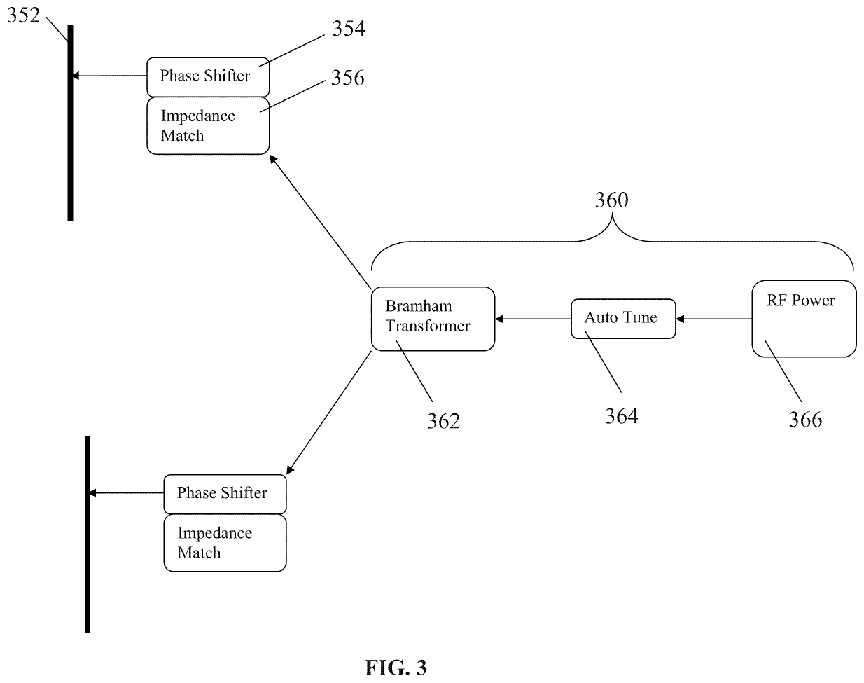

Referring now to FIG. 3, a diagram of a radio frequency de-bonding system 300 is depicted. Radio frequency de-bonding system 300 includes a plurality of metallic injectors 352, phase shifters 354, and impedance matchers 356. The plurality of metallic injectors 352, phase shifters 354, and impedance matchers 356 are electrically coupled to a central system 360. Central system 360 can include one or more Bramham transformers 362, auto tuner 364, and radio frequency generator 366. Auto tuner 364 is a device that can automatically maintain an impedance match between the metallic injectors 352 and the biomass that is being dried. Bramham transformers 362 can also be used to perform impedance matching functions within the system. An example of a suitable frequency generator 366 would be a phase-locked, class E, radio frequency power transmitter under the control of a microprocessor.

In embodiments, radio frequency de-bonding system 300 coupled to grain drying system 100 creates the ability to evaporate water at low temperature. Specifically, radio frequency de-bonding system 300 utilizes radio frequencies at frequencies around 13.56 MHz to bend or break the intermolecular hydrogen bonding and van der Waals dispersion interactions that are present in liquid water. This bending or breaking of the hydrogen bonds occurs as a result of being subjected to the magnetic field created by grain drying system 100.

The movement of water through a magnetic field or exposure to a varying magnetic field and its associated electromagnetic effect has been shown to disrupt intermolecular hydrogen bonding. This is because water is diamagnetic and may be polarized in magnetic fields. This polarization of water molecules physically moves and reorients the water molecules within a magnetic field. The orientation of the magnetic field is important with respect to hydrogen bond bending or breakage because any magnetic field aligned in the direction of the hydrogen bond increases the strength of the hydrogen bond whereas any magnetic field orthogonal to the direction of the hydrogen bond decreases the bond strength due to the reorientation forces that are created by the magnetic field.

Even partial alignment of the water molecules with an electric field will cause preexisting hydrogen bonding to become bent or broken thus reducing the surface tension and intermolecular bonding of water.

Thus, weak magnetic fields and stronger perpendicular magnetic fields have also been shown to increase the evaporation rate. As an added benefit, water that is exposed to constant transverse magnetic or electric fields also gives rise to a strong antimicrobial effect.

Once the intermolecular hydrogen bond is bent or broken within the grain or kernel, the new alignment of adjacent water molecules acts to repel each other effectively freeing the water molecule from intermolecular bonding. Then, with the flow of air created within to grain drying system 100, the water is removed from cavity 150.

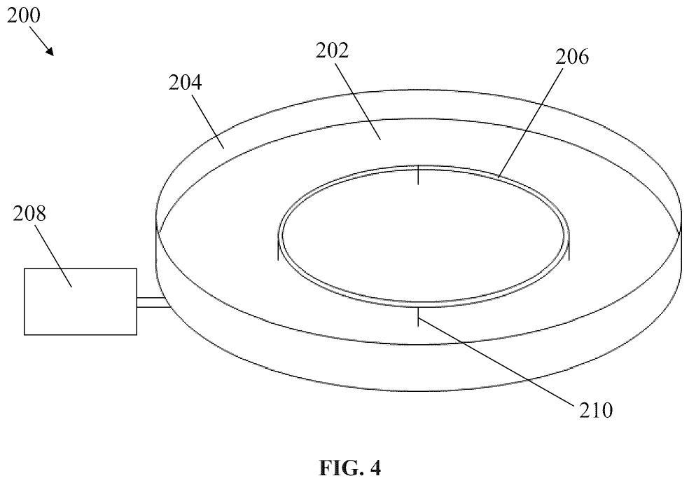

Referring now to FIG. 4 where a drying system 200 is depicted. In this embodiment, various materials can be dried using radio frequency energy emission coupled with material agitation. The various materials can include sand, biomaterials, or fertilizer precursors. In embodiments, drying system 200 includes a basin 202, retaining wall 204, radiator 206, and agitator 208. Basin 202 can be a circular disk shape or any other suitable shape. Basin 202 can further be configured to support the materials to be dried. Retaining wall 204 can be coupleable to the periphery of basin 202. Retaining wall 204 can be configured to hold the material to be dried and as such creating drying zone located above basin 202. Retaining wall 204 can also be configured to contain radio frequency emission to within the drying zone.

In embodiments, radiator 206 is coupleable to basin 202 via stands 210. In embodiments, stands 210 are configured to support radiator 206 and, at one or more stands, electrically couple radiator 206 to a radio frequency generator. To ensure proper placement of radiator 206 within a batch of material to be dried, stands 210 are configured to support radiator 206 at a height above the surface of basin 202, but below the top edge of retaining wall 204. Thus, radiator 206 is configured to be placed centrally, with respect to height, within the drying zone and to ensure that material to be dried covers radiator 206 entirely.

In embodiments, agitator 208 is coupleable to basin 202. Agitator 208 can comprise a motor having an offset weight, or in other embodiments, agitator 208 can include a plurality of magnetically controlled multiple linear actuators. Agitator 208 is configured to provide sinusoidal agitation to the material to be dried. Thus, basin 202 must be constructed to transmit the sinusoidal agitation provided by agitator 208 to the material to be dried.

In embodiments, radiofrequency energy is radiated into the material to be dried via radiator 206. In these embodiments, therefore, radiator 206 can be constructed with titanium coated beryllium/copper circular rods or with highly conductive ceramic of similar shape in order to survive the abrasive material movement such as sand. In some embodiments a plurality of radiators 206 can be included in the drying zone and coupled to basin 202. In embodiments surface area, length, shape and number of radiators 206 can be adjusted to the frequency of radiofrequency energy used as well as the volume of material to be dried.

Further in embodiments, sinusoidal agitation can be applied perpendicular to the broad face of basin 202 such that vertical motion is attained. The sinusoidal mechanical energy can be controlled by a controller and sensor system within by agitator 208 such that the lowest magnitude sinusoidal mechanical energy is used to dry the material.

Many industries and applications require moisture to be removed from the materials they handle. For example, agricultural crops need to be dried after harvest to preserve their taste and nutrients, reduce storage volume, increase storage life, prevent molding or bacteria growth etc. Similarly, moisture is removed from certain aggregate materials to obtain or retain certain physical and mechanical properties and to avoid any degradation. Further, moisture needs to be removed from manure and other waste for their easier disposal. One traditional moisture-removal technique, quite common with the agricultural products, is to spread out the material containing moisture over a large area and let it dry in the air. However, the space and time constraints make this method impractical for large volumes. Another common moisture-removal technique is the heat-assisted air-drying method in which a material to be dried is loaded into drying bins and hot air is forced through the material until the moisture is reduced to a certain level. This method, however, suffers from low energy efficiencies and leads to significant costs due to the requirement of a heat source either from hydrocarbon fuel or electrical sources. Another important drawback of heat-assisted air drying is the potential heat damage to, for example, the harvest crop as the even distribution of temperature is a big challenge in this drying method.

Industries have also recently considered utilizing electromagnetic radio frequency fields for drying various materials. For example, in agriculture industry, the harvest crop is subject to high-power electromagnetic fields. The electromagnetic energy absorbed by the harvest crop converts into heat, raising the temperature of the harvest crop and the mixed water. When the temperature is increased to the boiling point of the water, it evaporates out of the harvest crop. The electromagnetic heating of a material containing moisture relies on material's dielectric properties, which can be represented by the following equation (1):

ε(f)=εᵣ+jεᵢ (1)

Where ε is called the dielectric constant and is a function of frequency f of the applied electromagnetic fields. The dielectric constant ε is, in general, a complex quantity with εᵣ being its real part and εᵢ being its imaginary part. The ratio of imaginary part εᵢ to the real part εᵣ of the dielectric constant is called dielectric loss tangent, tan(d):

tan(d)=εᵢ/εᵣ (2)

The dielectric loss tangent, tan(d), is a measure of the dielectric absorption of a material. Higher the loss tangent value, higher is the absorption of the applied electromagnetic fields by the material. In general, the dielectric absorption increases with frequency, f. When two or more materials are mixed, the total absorption of the applied electromagnetic fields by the mixture depends on the volume fraction and dielectric properties of each component of the mixture. However, compared to most materials, the loss tangent of water may not be very high. Further, in most materials containing moisture that need to be dried, the volume fraction of the moisture content is significantly lower than that of the material in the mixture. Therefore, when a material-moisture mixture is exposed to electromagnetic radio frequency fields, most of the applied electromagnetic power is absorbed by the material and not by the water. As such, it is the grain, crop or the material in the mixture that absorbs most of the applied electromagnetic radio frequency fields and is heated directly while the temperature of water rises indirectly through convection. Therefore, to evaporate water out of a material, the temperature of the most volume of the material must first rise above the boiling point of water. As the temperature of the material-moisture mixture reaches the water's boiling point, the heated water eventually evaporates out of the material-moisture mixture. However, as the water content in the material-moisture mixture drops due to evaporation, the volume fraction of the material in the material-moisture mixture increases with the material absorbing more and more power from the applied electromagnetic fields. This leads to even higher temperatures in the already dried section of the material-moisture mixture as compared to the portions with significant water content, causing low heating efficiency and potential heat damage to the material in the material-moisture mixture. Further, the efficiency of the electromagnetic radio frequency drying system continues to drop as drying process progresses. As such, avoiding heat damage to the harvest crop or other materials in the final stages of electromagnetic radio frequency drying continues to be a challenge in the industry.

Yet another challenge to the radio frequency drying technique is that the dielectric loss tangent is a function of frequency with the dielectric loss tangent values increasing with frequency, in general. However, the ability of electromagnetic fields to penetrate into a material is inversely related to frequency. That is, while electromagnetic radio frequency drying maybe more efficient at higher frequencies, the electromagnetic field penetration into materials containing moisture is lower. Therefore, only a small amount of a material can be dried using conventional electromagnetic radio frequency drying techniques. For large volumes, electromagnetic radio frequency drying at higher frequencies leads to non-uniform heating with outer layers of the material drying faster while the internal layers remaining at lower temperature and not dried. Similarly, at lower frequencies, since the dielectric loss tangent values are relatively low, in general, higher amplitudes of electromagnetic fields are needed to achieve evaporation of the water. Another drawback of electromagnetic radio frequency moisture-removal method is that the dielectric properties of most materials are not readily available. Without the adequate knowledge of these properties, it is difficult to design an efficient electromagnetic radio frequency moisture-removal system. Further, the dielectric properties of a material-moisture mixture will vary throughout the drying process as moisture content as well as the total volume of the material-moisture mixture changes during the drying process. This means that an electromagnetic radio frequency moisture-removal system must be continuously adjusted and tuned to its load throughout the drying process. This slows down the drying, leading to poor time and energy efficiencies.

While the electromagnetic radio frequency moisture-removal systems have concentrated upon the absorption of electromagnetic energy by a material-moisture mixture, an important property of water has been neglected so far in these systems. That is the movement of water when it is subject to an external magnetic field. Exposure to a varying magnetic field and its associated electromagnetic effects have been shown to disrupt inter and intramolecular hydrogen bonds of water molecules. This is because water being diamagnetic becomes polarized in the presence of magnetic fields. This polarization of water molecules physically moves and reorients water molecules within a magnetic field. The orientation of the magnetic field is important with respect to hydrogen bond bending or breakage because any magnetic field aligned in the direction of the hydrogen bond increases the strength of the hydrogen bond whereas any magnetic field orthogonal to the direction of the hydrogen bond decreases the bond strength due to the reorientation forces that are created by the magnetic field. In addition, even the partial alignment of water molecules with an electric field will cause preexisting hydrogen bonding to become bent or broken, thus reducing the surface tension and hydrogen bonding of water. In fact, weak electric fields and strong perpendicular magnetic fields have been shown to increase the evaporation rate. As an added benefit, water that is exposed to constant transverse magnetic or electric fields also gives rise to a strong antimicrobial effect.

The inventers of the present disclosure have discovered that an efficient way to break the hydrogen bonding of water in a material-moisture mixture is to provide simultaneous transverse electric and magnetic fields. In the embodiments that are disclosed here, a fundamental propagating electromagnetic mode is launched in a material-moisture mixture using proper arrangement of metal conductors. Since a propagating electromagnetic field comprises transverse electric and magnetic field components, the material-moisture mixture is subject to electromagnetic de-bonding forces which guide the water contents out of a material-moisture mixture. The advantage of the disclosed methods is that water is not evaporated out of the material by heating the material-moisture mixture but instead the proper orientation of electromagnetic fields is used to guide the water out of the material-moisture mixture. In fact, the inventors have observed that the water can be removed in some cases while the material-moisture fixture remains at freezing temperature. As such, the disclosed methods are highly energy efficient and eliminate any potential damage to the materials, such as harvest crop, in a material-moisture mixture.

In the disclosed embodiments, the moisture-removal system designs include structures that allow a propagating electromagnetic wave to travel within a material-moisture mixture such as harvest crop or biomass material. This contrasts the present disclosure with existing electromagnetic radio frequency moisture-removal systems which use dielectric or electrostatic heating of the materials. A propagating electromagnetic wave can be launched by an arrangement of electrical conductors, spaced apart appropriately for a given frequency, and the material-moisture mixture placed within these electrical conductors. Since the needed spacing between the electrical conductors depends upon the dielectric properties of the material in between the conductors, the spacing must be varied as the water content in the material-moisture mixture drops during the drying process. Alternately, the space between the electrical conductors is only partially filled with the material-moisture mixture and hence the impact of material-moisture mixture's dielectric properties on the wave impedance of the propagating electromagnetic mode is minimal. Such partial fulfillment of the space avoids constant adjustment of the spacing between the electrical conductors to maintain the wave impedance of the propagating electromagnetic mode.

In one embodiment, two electrical conductors are arranged such that a propagating electromagnetic wave can be launched in the material-moisture mixture. In another embodiment, three conductors are arranged such that a propagating electromagnetic wave can be launched in the material-moisture mixtures. Further provisions, such as ventilation holes in the electrical conductors can be provided to allow forced air flow through the moisture-removal system. These ventilation holes, as long as their size is only a small fraction of the wavelength (generally, less than one tenth of the wavelength), do not impact the wave impedance of the propagating electromagnetic modes. In yet another embodiment, the moisture-removal system comprises several moisture-removal subsystems acting in a cascaded manner. These small moisture-removal systems include electric conductors spaced apart and placed above a conducting platform. Before drying process starts, these subsystems are tuned to different moisture content levels for a given material-moisture mixture. The conducting platform comprises of moving rails or plates that can push the material-moisture mixture from one moisture-removal subsystem to the next. As such, when a material-moisture mixture with high water content is placed on the conducting platform, the mixture is moved from one subsystem to the next and the drying progresses almost in a continuous manner.

As is generally understood, the strength of electromagnetic fields is uniform in between the conductors supporting a propagating electromagnetic field. As such, location of the material within such structures should not be important. However, the inventors of this disclosure have surprisingly found that the material that comes in the contact with the metal conductors dries faster. As such, the present embodiments provide preferred embodiments where the material stays in contact with at least one metal conductor throughout the drying process.

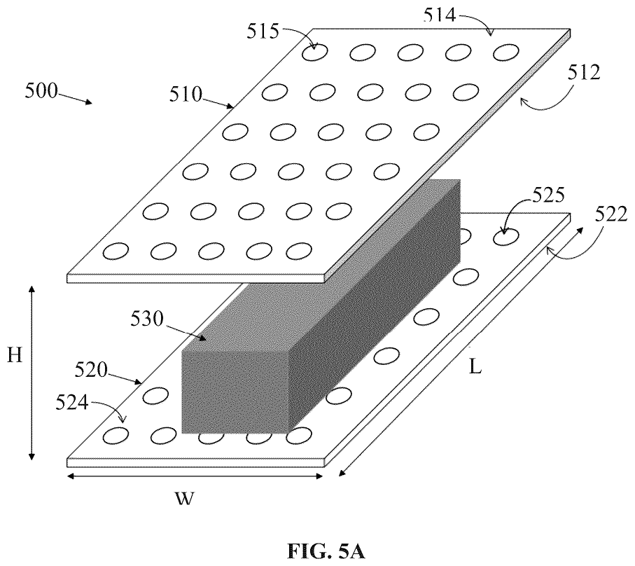

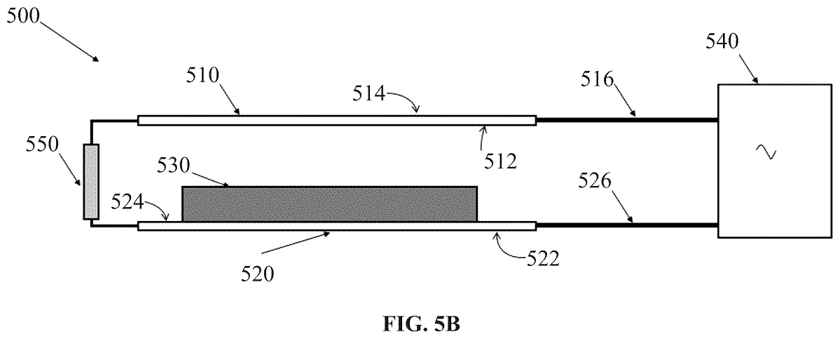

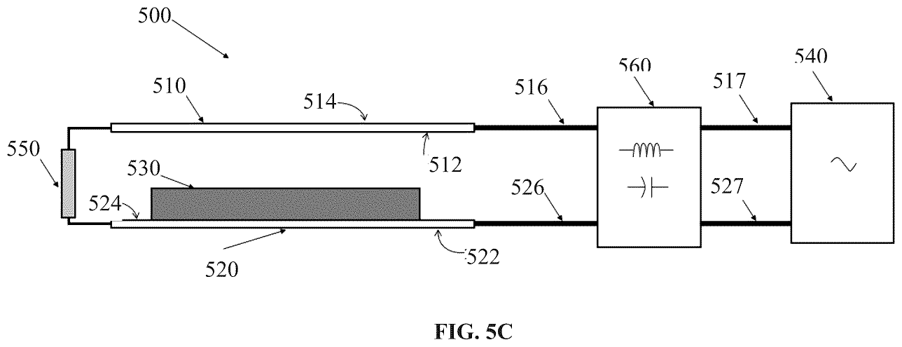

FIG. 5A shows a perspective view of the biomass moisture-removal system 500, according to one aspect of the disclosure. The biomass moisture-removal system 500 includes spaced apart first electrical conductor 510 and second electrical conductor 520, each having the same width “w”, and extending along a first direction for a length L. The first electrical conductor 510 includes a first broad top side 514, and a first broad bottom side 512, and the second electrical conductor 520 includes a second broad top side 524, and a second broad bottom side 522. The first and second electrical conductors 510, 520, are disposed such that the first broad bottom side 512 faces the second broad top side 524. A biomass material 530 that needs to be dried is disposed of in between the first electrical conductor 510 and the second electrical conductor 520. In some cases, the biomass material 530 completely fills the space between the first and the second electrical conductors 510 and 520; however, in other cases, the biomass material 530 only partially fills the spacing between the first and the second electrical conductors 510 and 520. To launch a propagating electromagnetic wave in between the two electrical conductors, the height “h” between the first and the second electrical conductor, 510 and 520, and their width “w” must be carefully chosen. However, these values depend on the dielectric constant ε1 of the biomass material. Further, the value of ε1 depends on the amount of moisture present in the biomass material. Therefore, as the drying process progresses and the water is removed from the biomass material, value of ε1 will change. As such, the height “h” and width “w” may need to be continually adjusted to avoid any RF reflections to the RF generator. Alternately, if the biomass material 530 occupies a very small space between the first electrical conductor 510 and the second electrical conductor 520, then effect of ε1 of the biomass material on the width “w” and height “h” can be ignored. The propagating electromagnetic wave will help break the hydrogen bond of the moisture with the biomass material. Once the bond is broken the water can flow easily. To remove the water from the system, biomass moisture-removal system may include a fan that pushes the air through the biomass material, according to another aspect of the disclosure. To provide air flow, the first and the second electrical conductors 510, 520 are respectively provided with small holes 515 and 525.

FIG. 5B shows a cross-sectional view of the biomass moisture-removal system 500, according to one aspect of the disclosure. As illustrated, the biomass moisture-removal system 500 is connected to a first RF generator 540 via two electrical wires 516 and 526. Wire 516 connects the first electrical conductor 510 to the RF output port of RF generator 540 while the wire 526 connects the second electrical conductor 520 to the ground of RF generator 540. Alternatively, the wires 516 and 526 can form a first coaxial cable, according to yet another aspect of the present disclosure, with wire 516 being the central conductor of the first coaxial cable and wire 526 being the outer shield of the first coaxial cable. The other end of the biomass moisture-removal system 500, can either be left open or it can be connected with a matched load, e.g. 50 ohms, to avoid any RF reflections back to the biomass moisture-removal system. The direct connection of the first RF generator 540 with the biomass moisture-removal system 500, as illustrated in FIG. 5B, may be sufficient for small lengths of the moisture-removal systems and for small RF powers. For relatively larger sizes of the moisture-removal systems, the input impedance of the moisture-removal system must be carefully matched with the wires/coaxial cables supplying the RF power from the RF generator 540. One possible embodiment is illustrated in FIG. 5C, according to yet another aspect of the present disclosure. Here, an impedance matching network 560, comprising at least one variable inductor and one variable capacitor. By varying the inductance and the capacitance of the matching network 560, the reflected RF power to the RF generator 540 can be reduced.

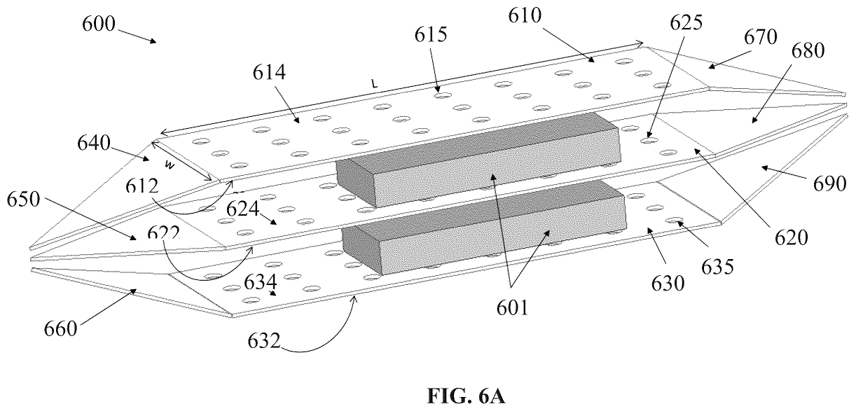

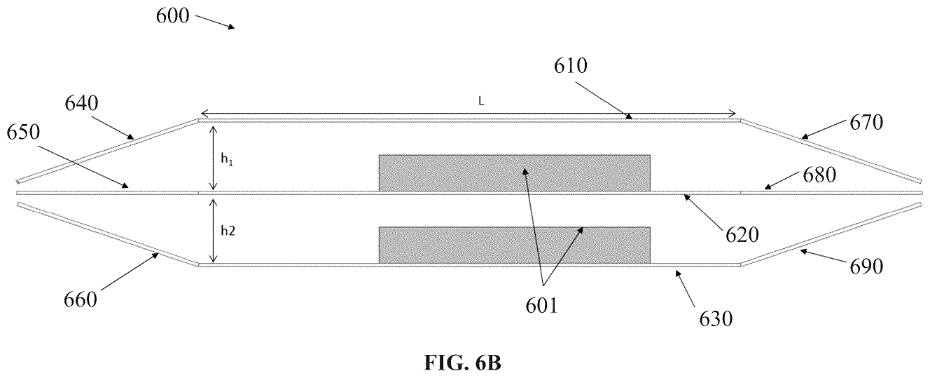

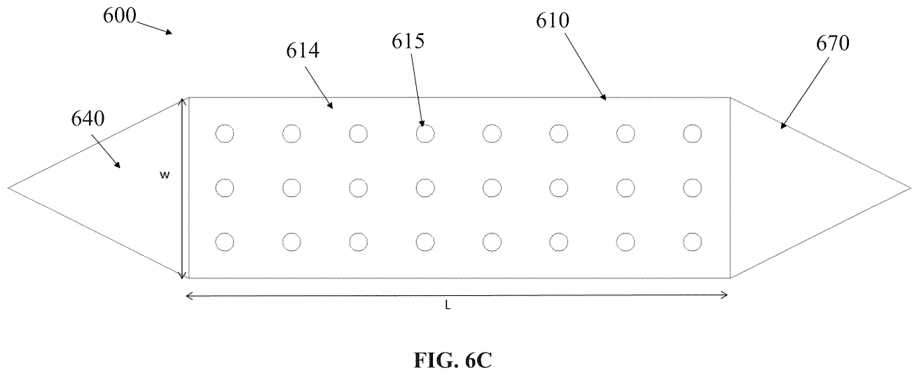

FIG. 6A provides a perspective view of yet another aspect of the present disclosure that avoids the need to continually match the input impedance using a matching network. FIG. 6B provides the side and FIG. 6C provides the top view of the same embodiment of the disclosed moisture-removal system. As illustrated, the disclosed moisture-removal system 600 includes spaced apart a first electrical conductor 610, a second electrical conductor 620 and a third electrical conductor 630, each having the same width “w” and each extended along a first direction for a length “L”. The first electrical conductor 610 includes a first broad top side 614, and a first broad bottom side 612, the second electrical conductor 620 includes a first broad top side 624, and a second broad bottom side 622, and the third electrical conductor 630 includes a first broad top side 634 and a second broad bottom side 632. The electrical conductors 610, 620, and 630 are arranged such that the broad bottom side 612 of 610 faces the broad top side 624 of 620 and the broad bottom side 622 of 620 faces the broad top side 634 of 630. A material 601 containing moisture is placed in between either the conductors 610 and 620 or between 620 and 630. To launch a propagating electromagnetic wave in between these electrical conductors, the height “h₁” between the conductors 610 and 620 and the height “h₂” between conductors 620 and 630 along with the width “w” of 610, 620 and 630 must be carefully chosen. However, these values depend on the dielectric constant ε of the material 601. Further, the value of ε depends on the volume percentage of the moisture content present in the material 601. As the drying process progresses and the water is removed from the material 601, value of ε will change. As such, the heights “h₁” and “h₂” as well as the width “w” may need to be continually adjusted to avoid any impedance mismatch with the impedance of the feed line from the radio frequency generator. Alternately, if the material 601 occupies very small volume of the space between the conductors 610 and 620 or between 620 and 630, then effect of ε on the width “w” and the heights “h₁” and “h₂” can be ignored. The propagating electromagnetic wave will break the hydrogen bond of the moisture with the material 601 and once the bond is broken the water will flow out of the material easily. To remove the water, the moisture-removal system may include a fan that pushes the air through the material 601, according to another aspect of the disclosure. To provide air flow, the electrical conductors 610, 620 and 630 are provided with small holes 615, 625 and 635. The air can be forced or sucked out via a fan. Since the disclosed embodiments are used to break the Hydrogen bond of water from the material, and not to evaporate the water, it is easier to arrange the moisture-removal system and the forced airflow such that the water flows in the direction of gravity. The largest dimension of these holes 615, 625 and 635 must not be greater than one tenth of the operating radio frequency wavelength. However, practical reasons may further limit the size of these holes. For example, a part of material 601 may fall through the holes if they are too large. Similarly, there is no limit to the minimum size of the holes 615, 625 and 635, as long as the proper airflow can be maintained. The moisture-removal system 600 also includes three electrical conductors 640, 650 and 660 on the first end 601. The electrical conductors are arranged such that the broad bottom side of 640 faces the broad top side of 650 and broad bottom side of 650 faces broad top side of 660. The conductor 640 is attached to conductor 610, the conductor 650 is attached to the conductor 620 and the conductor 660 is attached to the conductor 630. At the plane of their attachment, the width of 640 is the same as the width of 610, the width of 650 is the same as the width of 620 and the width of 660 is the same as the width of 630. However, the widths of 640, 650 and 660 gradually decreases away from the plane of attachment. Similarly, at the plane of attachment, the distance between 640 and 650 is the same as the distance between 610 and 620 and the distance 650 and 660 is equal to the distance between 620 and 630. However, the distance between 640 and 650 as well as the distance between 650 and 660 continuously decrease away from the plane of attachment. At the farthest plane of connection the distances between these conductors and their widths become small enough that a standard RF coaxial connector can be attached such that the center pin of the coaxial connector is attached to 650 and while 640 and 660 are attached to the ground of the coaxial connector. The gradual increase in the widths of 640, 650 and 660 and their inter-spacing provides a gradual transformation of the coaxial electromagnetic mode to the parallel plate transmission line mode. As such, 640, 650 and 660 together form an impedance or a mode transition network where at every point along the length of this transition, the widths and their inter-spacing must be chosen such that impedance of the transition remains the same as that of the conductors 610, 620 and 630. In most case, the transition (conductors 640, 650 and 660) at the RF input should be sufficient. While at the second end of the moisture-removal system 600, lumped loads can be connected. However, if needed a similar transition formed by conductors 670, 680 and 690 can be used. The benefit of using these transitions, especially at the input, is that it eliminates the need for the matching network of FIG. 5C.

An alternative embodiment includes a moisture-removal system, comprising: having spaced apart a first and a second and a third electrical conductor extending along a same first direction, each electrical conductor comprising opposing broad top and bottom sides and opposing narrow edges, the broad bottom side of the first electrical conductor facing the broad top side of the second electrical conductor and the broad bottom side of the second electrical conductor facing the broad top side of the third electrical conductor; and a material containing moisture at least partially filling the space between the first and the second electrical conductor or between the second and the third electrical conductor; and at least one first wire with a first end and a second end, the first end of the first wire attached to a first radio frequency generator and the second end of the first wire attached to the first end of the second electrical conductor; and at least one second wire with a first and a second end, with the first end of the second wire attached to the electrical ground of the first radio frequency generator and the second end of the second wire attached to the first end of the first electrical conductor; and at least a third wire with a first and a second end, with the first end of the third wire attached to the electrical ground of the first radio frequency generator and the second end of the third wire attached to the first end of the third electrical conductor. This embodiment can include where the material containing moisture makes a direct contact with either of the first or the second or the third electrical conductor. This embodiment can also include where the material containing moisture makes a direct contact with all three first, second and the third electrical conductor. This embodiment can also include where the material containing moisture makes no contact with any of the first or the second or third electrical conductor. This embodiment can also include where the radio frequency of the first radio frequency generator is between 1 MHz to 1 GHz. This embodiment can also include where the radio frequency of the first radio frequency generator is 13.56 MHz. This embodiment can also include where the radio frequency power of the radio frequency generator is at least 500 watts. This embodiment can also include where the radio frequency power of the first radio frequency generator is at least 1000 watts. This embodiment can also include where the radio frequency power of the first radio frequency generator is at least 1000 watts. This embodiment can also include where the second and the third wire constitute an outer shield of a first coaxial cable and the first wire constitute the central conductor of the first coaxial cable.

Another embodiment of a moisture-removal system, includes having spaced apart a first and a second and a third electrical conductor extending along a same first direction, each of the first and second and the third electrical conductor comprising opposing broad top and bottom sides and opposing narrow edges, the broad bottom side of the first electrical conductor facing the broad top side of the second electrical conductor and the broad bottom side of the second electrical conductor facing the broad top side of the third electrical conductor; and a material containing moisture at least partially filling the space between the first and the second electrical conductor or the space between the second and the third electrical conductor; and a first inductor-capacitor assembly of at least one inductor and at least one capacitor, the inductor and the capacitor electrically attached with each other; the first inductor-capacitor assembly having a first end, a second end and a third end; and at least one first wire with a first end and a second end, the first end of the first wire attached to a first radio frequency generator and the second end of the first wire attached to the first end of the first inductor-capacitor assembly; and at least one second wire with a first end and a second end, with the first end of the second wire attached to the electrical ground of the first radio frequency generator and the second end of the second wire attached to the third end of the first inductor-capacitor assembly; and at least a third and a fourth electrical wire, each with a first end and a second end, the first end of the third wire attached to the second end of the first inductor-capacitor assembly, and the second end of the third wire attached to the first end of the second electrical conductor; and the first end of the fourth wire is attached to the third end of the first inductor-capacitor assembly and the second end of the fourth wire attached to the first end of the first electrical conductor and to the first end of the third electrical conductor. This embodiment can also include where the material containing moisture makes a direct contact with either of the first or the second or the third electrical conductor. This embodiment can also include where the material containing moisture makes a direct contact with all three first, second and the third electrical conductor. This embodiment can also include the material containing moisture makes no contact with any of the first or the second or third electrical conductor. This embodiment can also include where the radio frequency of the first radio frequency generator is between 1 MHz to 1 GHz. This embodiment can also include where the radio frequency of the first radio frequency generator is 13.56 MHz. This embodiment can also include where the radio frequency power of the radio frequency generator is at least 500 watts. This embodiment can also include where the radio frequency power of the first radio frequency generator is at least 1000 watts. This embodiment can also include where the radio frequency power of the first radio frequency generator is at least 1000 watts. This embodiment can also include where the first wire is a central conductor of a first coaxial cable and the second wire is the outer shield of the first coaxial cable and the third wire is a central conductor of a second coaxial cable and the fourth wire is an outer shield of the second coaxial cable.

Yet another alternative embodiment of a moisture-removal system includes a first assembly of having spaced apart a first, a second and a third electrical conductor, each with a first end and a second end, extending along a same first direction, each conductor comprising opposing broad top and bottom sides and opposing narrow edges, the broad bottom side of the first electrical conductor facing the broad top side of the second electrical conductor and the broad bottom side of the second electrical conductor facing the broad top side of the third electrical conductor; and a material containing moisture at least partially filling the space between the first and the second electrical conductor or the space between the second and the third electrical conductor; and a second assembly of having spaced apart a fourth, a fifth and a sixth electrical conductor, each with a first end and a second end, extending long the same first direction and comprising opposing broad top and bottom sides and opposing narrow edges, the broad bottom side of the fourth electrical conductor facing the broad top side of the fifth electrical conductor and the broad bottom side of the fifth electrical conductor facing the broad top side of the sixth electrical conductor; and the distance between the opposing narrow edges of each of the fourth, fifth and sixth electrical conductor gradually varying and the spacing between the fourth, fifth and sixth conductor gradually varying such that the second end of the fourth conductor is as wide as the first end of the first conductor, the second end of the fifth conductor is as wide as the first end of the second conductor and the second end of the sixth conductor is as wide as the first end of the third electrical conductor, and the spacing between the second ends of the fourth and the fifth conductor is equal to the spacing between the first ends of the first and the second conductor, and the spacing between the second ends of the fifth and sixth conductors is equal to the spacing between the first ends of the second and third conductors; and the distance between the opposing narrow edges of the fourth, fifth and sixth conductor at their first ends and the spacing between the fourth, fifth and sixth conductor is such that a first coaxial connector of suitable size can be mounted on these conductors with the outer ground of the connector making a contact with the fourth and sixth conductor and the center pin of the coaxial connector making a contact with the fifth conductor; and the second end of the fourth conductor attached to the first end of the first conductor, the second end of the fifth conductor attached to the first end of the second conductor and the second end of the sixth conductor attached to the first end of the third conductor; and at least one first coaxial cable with a first end and a second end, the first end of the first coaxial cable is attached to a first radio frequency generator and the second end of the first coaxial cable is attached to the first coaxial connector. This embodiment can also include where the material containing moisture makes a direct contact with any of the first or the second or the third electrical conductor. This embodiment can also include where the material containing moisture makes a direct contact with each of the first, the second and the third electrical conductor. This embodiment can also include where the material containing moisture makes no contact with any of the first, the second or third electrical conductor. This embodiment can also include where the radio frequency of the first radio frequency generator is between 1 MHz to 1 GHz. This embodiment can also include where the radio frequency of the first radio frequency generator is 13.56 MHz. This embodiment can also include where the radio frequency power of the radio frequency generator is at least 500 watts. This embodiment can also include where the radio frequency power of the first radio frequency generator is at least 1000 watts. This embodiment can also include where the radio frequency power of the first radio frequency generator is at least 1000 watts.

This embodiment can also include which also includes a third assembly of having spaced apart a seventh, an eighth and a ninth electrical conductor, each with a first end and a second end, extending along the same first direction and comprising opposing broad top and bottom sides and opposing narrow edges, the broad bottom side of the seventh electrical conductor facing the broad top side of the eighth electrical conductor and the broad bottom side of the eighth electrical conductor facing the broad top side of the ninth electrical conductor; and the distance between the opposing narrow edges of each of the seventh, eighth and ninth electrical conductor gradually varying and the spacing between the seventh, eighth and the ninth conductor gradually varying such that the second end of the first conductor is as wide as the first end of the seventh conductor, the first end of the eighth conductor is as wide as the second end of the second conductor and the first end of the ninth conductor is as wide as the second end of the third electrical conductor, and the spacing between the first ends of the seventh and the eighth conductor is equal to the spacing between the second ends of the first and the second conductor, and the spacing between the first ends of the eighth and ninth conductors is equal to the spacing between the second ends of the second and third conductors; and the distance between the opposing narrow edges of the seventh, eighth and ninth conductor at their second ends and the spacing between the seventh, eighth and ninth conductor is such that a second coaxial connector of suitable size can be mounted on these conductors with the outer ground of the second coaxial connector making a contact with the seventh and ninth conductor and the center pin of the second coaxial connector making a contact with the eighth conductor; and the first end of the seventh conductor attached to the second end of the first conductor, the first end of the eighth conductor attached to the second end of the second conductor and the first end of the sixth conductor attached to the second end of the third conductor. This embodiment can also include where the material containing moisture makes a direct contact with any of the first or the second or the third electrical conductor. This embodiment can also include where the material containing moisture makes a direct contact with each of the first, the second and the third electrical conductor. This embodiment can also include where the material containing moisture makes no contact with any of the first, the second or third electrical conductor. This embodiment can also include the radio frequency of the first radio frequency generator is between 1 MHz to 1 GHz. This embodiment can also include where the radio frequency of the first radio frequency generator is 13.56 MHz. This embodiment can also include where the radio frequency power of the radio frequency generator is at least 500 watts. This embodiment can also include where the radio frequency power of the first radio frequency generator is at least 1000 watts. This embodiment can also include where the radio frequency power of the first radio frequency generator is at least 1000 watts.

Another embodiment of a moisture-removal system includes a first assembly of electrical conductors, each extending along a same first direction with each conductor having a first and a second end and each comprising opposing broad top and bottom sides and opposing first and second narrow edges, the conductors of the first assembly arranged in a same second direction such that the second narrow edge of the first electrical conductor facing the first narrow edge of the second electrical conductor and the second narrow edge of the second electrical conductor facing the first narrow edge of the third electrical conductor and so on, and a first conducting platform having a length not smaller than any of the conductor of the first assembly and a width not smaller than the distance from the first narrow edge of the first electrical conductor to the second narrow edge of the last electrical conductor of the first assembly, the first assembly of the electrical conductors placed above the first conducting platform such that the broad bottom side of each conductor of the first assembly facing the conducting platform, and a material containing moisture at least partially filling the space between the first assembly of the electrical conductors and the first conducting platform; and a plurality of electric cables and wires that connect the first end of each conductor of the first assembly to a first radio frequency power source and the first conducting platform to the common electrical ground of the same first radio frequency power source. This embodiment can also include where the first conducting platform comprises moving plates or rails that push the material containing moisture along the second direction. This embodiment can also include where each electrical conductor of the first assembly have at least one hole from its broad bottom side to its broad top side. This embodiment can also include where the first assembly comprises at least four electrical conductors. This embodiment can also include where the first assembly comprises at least three electrical conductors. This embodiment can also include where the first assembly comprises at least two electrical conductors. This embodiment can also include where the material containing moisture is a harvest crop. This embodiment can also include where the material containing moisture is a waste material including manure. This embodiment can also include where the material containing moisture is a construction aggregate material.

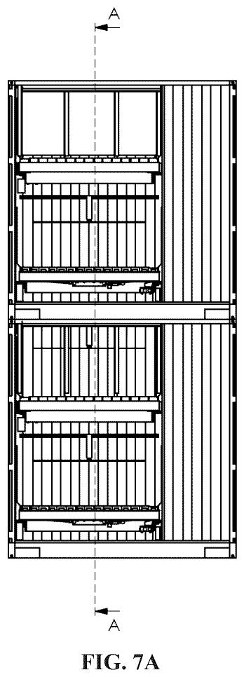

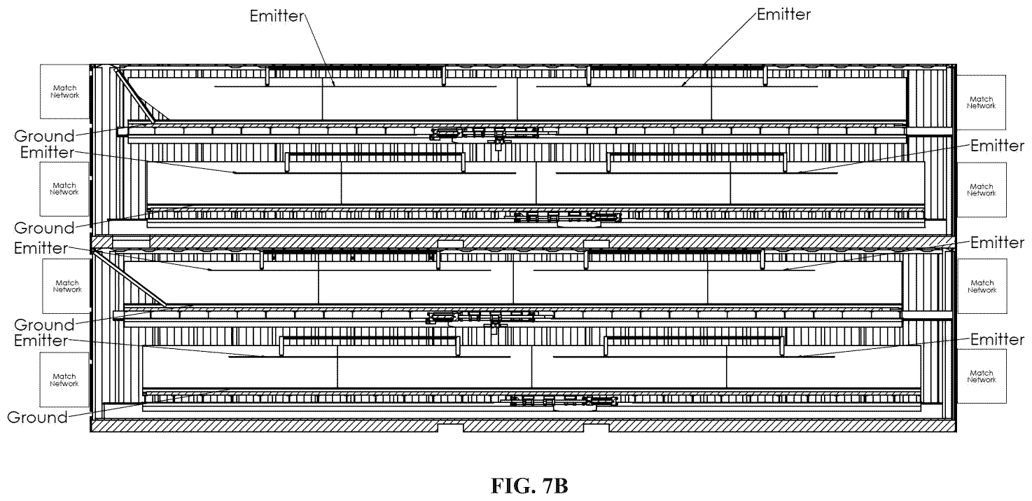

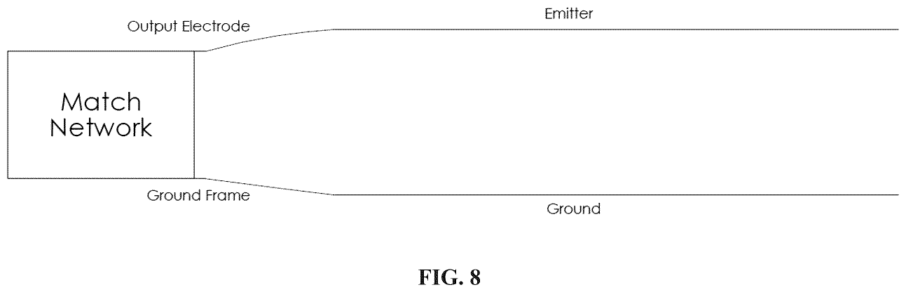

Referring to FIG. 7A-8, a continuous flow radio frequency container dryer that dries agricultural biomass material is depicted. In embodiments, the container dryer can be divided into two or more zones with each zone set to receive material at a specific moisture content. Referring to FIG. 7B, the container dryer can be divided into eight distinct zones. Each zone contains a pair of parallel plates with one plate being a hot conductor, or emitter, and the other plate being a ground plate. A voltage potential difference is created between the plates to induce electrical field coupling into the material, inducing ionic migration and dipole rotation that in-turn results in water release. Each zone is fed by an RF source with an automatic matching network between them, as shown in FIG. 8. The auto-match facilitates maximum power transfer from the RF source to the capacitor plates. The flow of material is facilitated by a push-pull metallic floor which also acts as the grounding structure for the RF return current.

In embodiments, the container dryer can be divided among shipping containers that each house zones. Referring to FIG. 7A-B, a container dryer using two shipping containers that each house four zones is depicted. The emitter plates are controlled by hydraulics to handle material of varying thickness. A fan on the side of the dryer is powering a plenum with uniform airflow going into the material. In embodiments, the fan can be a 2-horsepower fan. The high humidity air from the material is vacuumed out of the dryer by an outlet fan on each floor of the dryer. In embodiments, the RF is assisted with hot air sourced from a propane tank kept at the inlet of the fan to maintain an even bed temperature. Combining a convective drying system with the RF has an upward effect on the drying rate of the system.

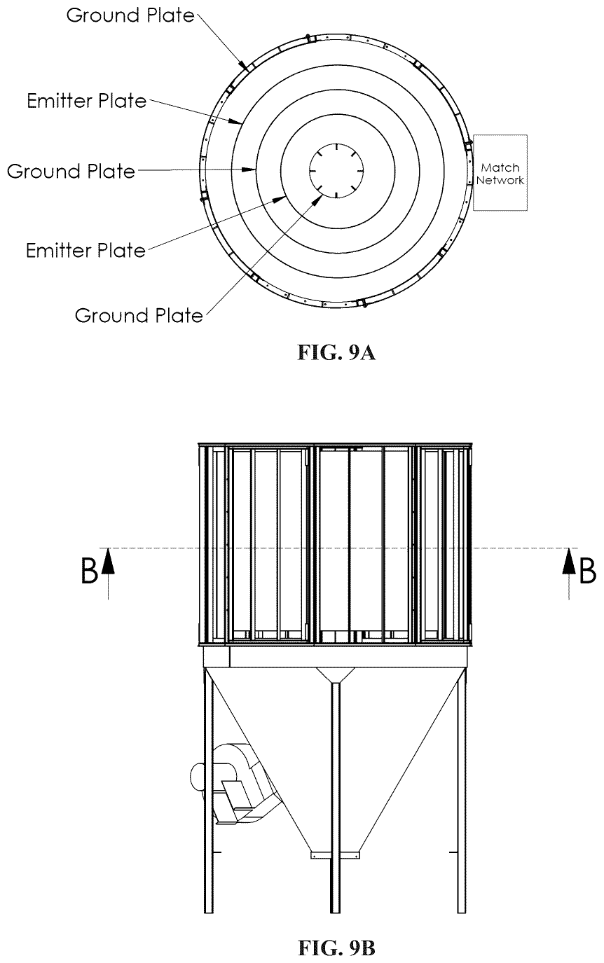

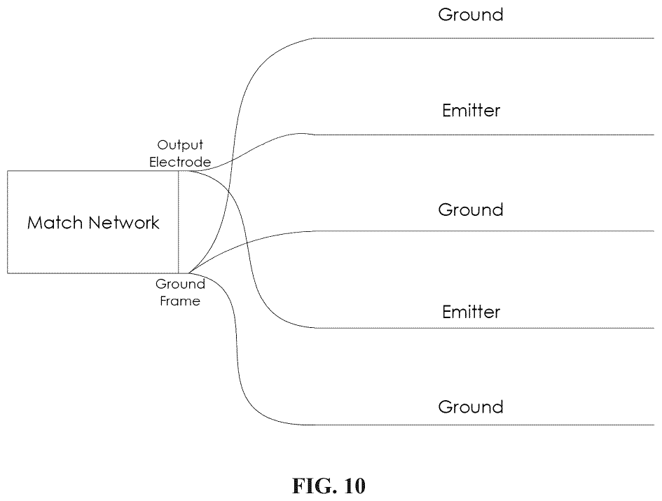

Referring to FIG. 9A-10, a radio frequency based cylindrical dryer that can dry granular agricultural material is depicted. The grain can be fed from the top of the cylindrical dryer using an auger system. The cylindrical architecture of the cylindrical dryer can hold a larger volume. In embodiments, the cylindrical dryer can be divided into zones height-wise. In such embodiments, each zone can contain at least one circular plate. In one embodiment, the cylindrical dryer has two zones divided height-wise and each zone contains three circular plates bent circularly, creating a 5-plate parallel plate capacitor configuration, as shown in FIG. 9A. The input power coming from the RF source is split between two emitter sections that induce a voltage potential difference between the plates and capacitively couple electrical fields into the granular material. This coupling of fields into the material causes ionic migration and dipole rotation, leading to water migration to the outside of the material. As shown in FIG. 10, each zone has a matching network present to maximize power transfer to the emitter plates. In embodiments, the cylindrical dryer has a conical air plenum which is sourced by a fan that uniformly blows the air into the material to get the moisture out of the system. In embodiments, the fan can be a 2-horsepower fan.

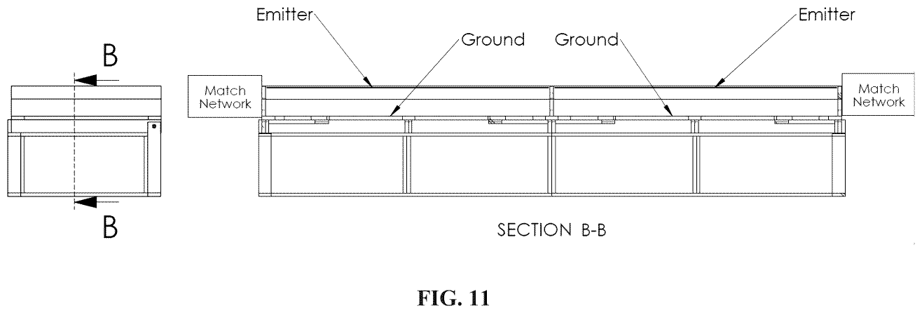

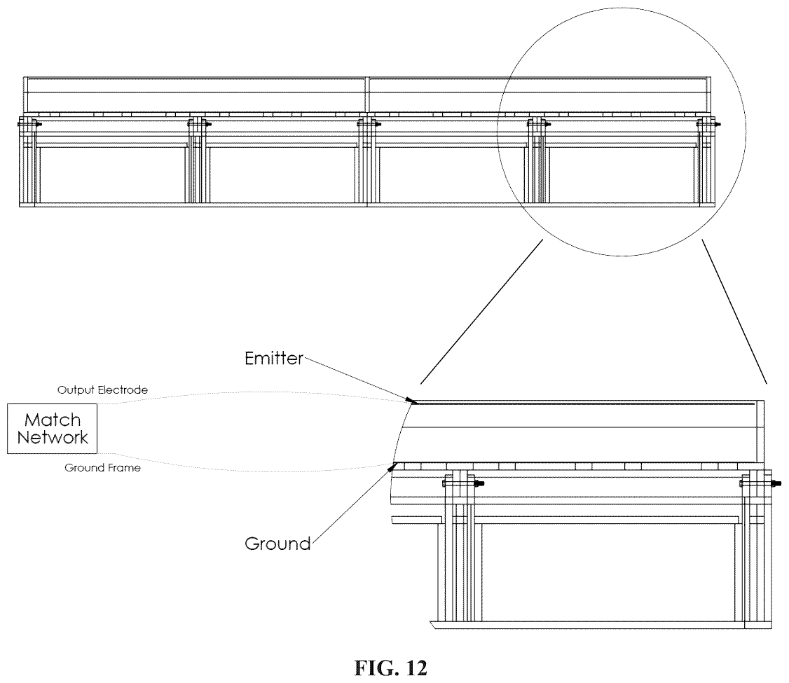

Referring to FIG. 11-12, a radio frequency based length-cuboid dryer used to dry agricultural biomass material is depicted. The material to be dried is placed in between two plates. In embodiments, the material can be of varying thickness from 6 inches to 2 feet. The geometry of the length-cuboid dryer body is a cuboid with the length of the dryer as the dominant dimension. As shown in FIG. 11-12, one plate acts as the hot conductor, or emitter, and the other as a ground plate. Two RF sources are used to power the length-cuboid dryer from either end. Each source is connected to a match network, as shown in FIG. 12, which facilitates maximum power transfer to the material. To get an efficient heating pattern, both RF sources share the same emitter and ground plates. The generators operate at an alternating time pulse, so any kind of interference is mitigated. The coupling of RF energy to the material instigates ionic migration and dipolar rotation which breaks the intra molecular water bonds. A fan is placed on either sides of the length-cuboid dryer in the air chamber to vacuum out high humidity air from the heating bed. In embodiments, the fan can be a 2-horsepower fan.

In embodiments, inducing alternating time pulsed RF signals from either end of the system increases the RF heating pattern. The amplitude of the RF wave decays as it is traveling from the source to the destination, so it is beneficial to use two systems on the same machine with an alternating time pulse to create a better heating pattern. For low loss factor materials, good thermal transmission effects can be achieved with just a single RF source. If the dielectric loss factor is high for the frequency of operation, thermal runaway effects and hotspots can occur that locally magnify the thermal effects at the source point, making the transmission of RF minimal.

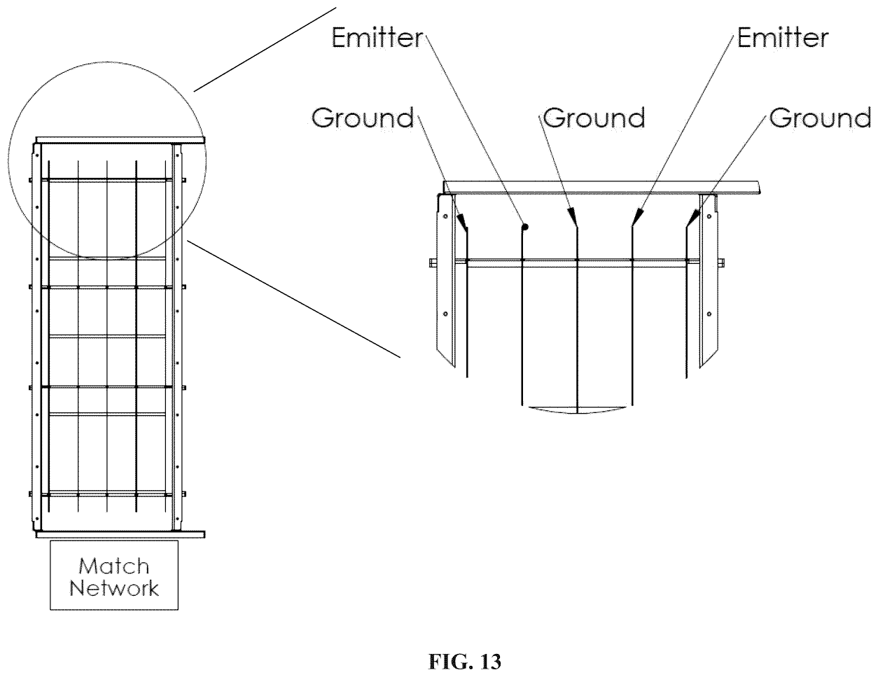

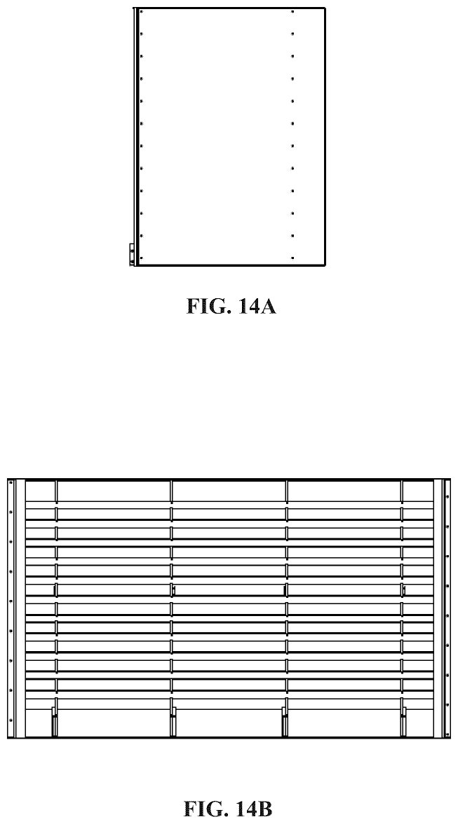

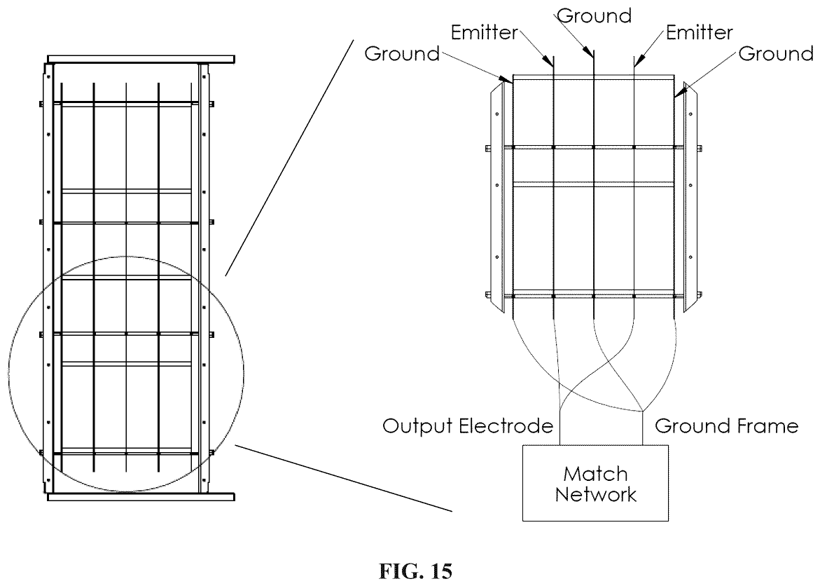

Referring to FIG. 13-15, a radio frequency based height-cuboid dryer used to dry granular agricultural material is depicted. The geometry of the height-cuboid dryer is cuboid based with the height being the dominant dimension. The material to be dried is fed from the top of the height-cuboid dryer. The height-cuboid dryer is divided into different zones which dries material based on the moisture content of the incoming grain. The residency time of the dryer is adjusted such that each zone receives grains with a set moisture content. Each zone consists of a series of at least five plates which is powered by an RF source. These plates capacitively couple RF energy to the grain which induces ionic migration and dipole rotation responsible for the breakage of the O—H bond between water molecules. An automatic matching network, as shown in FIG. 15, is placed between the RF source and the emitter plates that facilitates maximum power transfer from the RF source to the capacitor.

Referring to FIG. 13, an embodiment of one zone of the height-cuboid dryer is depicted. Two plates are the signal conducting plates and three plates are the ground plates. A voltage potential difference is created between these plates which is absorbed by the granular material. The power density going into the material can be adjusted by changing the plate surface area or by changing the distance between the plates. The height-cuboid dryer follows a continuous flow mechanism with wet grain fed from the top and dry grain received at the bottom. A fan is used to pressurize a plenum which uniformly distributes airflow throughout the granular material which removes the water released from the effects of radio frequency coupling. In embodiments, the fan can be a 250-horsepower fan.

When a material to be dried, such as grain, is wet, the material has a low resistance and high permittivity. At this point, in order to dry more volumetric material the distance between the plates is increased to maintain a certain voltage and current going into the system, but as the grain dries, the grain becomes more resistance to the current with the same operating voltage. At this point, reducing the distance between the plates and/or reducing the place area to increase the operating voltage can be effective methods of having more power going into the system.

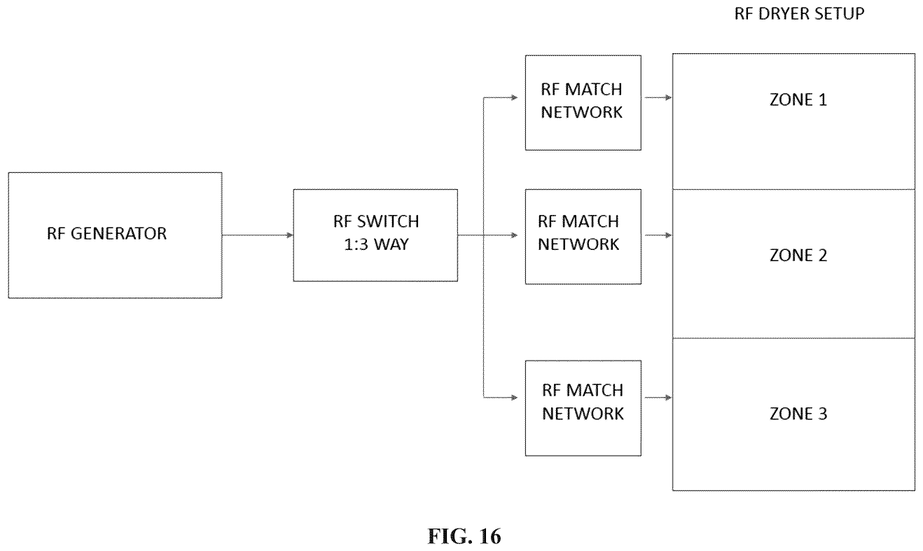

Referring to FIG. 16, a block diagram of a RF switch implementation is shown according to an embodiment. In embodiments, RF switches can reduce capital costs of using multiple generators to power a multi-zone dryer system. The RF switch provides multiple paths to route the RF, allowing a single RF source to simultaneously reach different zones. The switches can be synchronized using an external watchdog timer to the RF generator such that the switches only turn on when the RF power is off. This synchronization can improve the lifetime of the RF switch. The dwell time on the switching zones can be set in milliseconds such that fast switching between the zones is enabled.

The RF switches can be used in larger dryer systems involving many drying zones. The ‘matches’ can be fixed or auto tuned. The matches will be controlled by an algorithm based on material properties of the material being dried. Relevant properties include: moisture of the material at the point of the emitter and the match; humidity of the ambient air, the material, and exit air; temperature of the ambient air, the material, and the exit air; and airflow. Calculation of the airflow is based on a volumetric analysis of quantitative fluid dynamics and material flow rate throughout the continuous flow process.

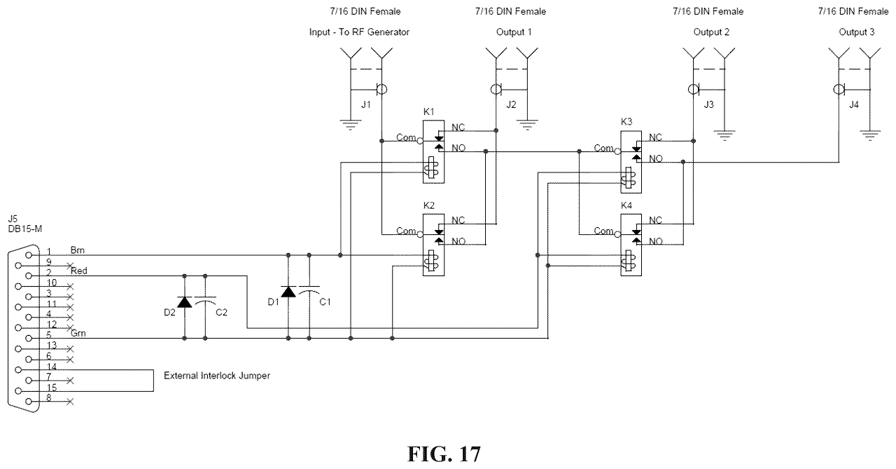

Referring to FIG. 17, a diagram of an RF switch system is depicted. In embodiments, a RF switch can “auto switch” to the next line once the power in the RF generator goes “off” in a system where the pulse power is on/off and any time variable is used. Such an automatic switch can be done at ½ second, ½ second off or 1 minute on, 5 minutes off, or micro second (x) on microsecond (y) off. The loss of power signals the switch to ‘switch’ power lines to the next setting in a consecutive pattern. Thus, when implemented in a dryer system, an RF generator can alternated between as many zones, or power lines, as desired, allowing only one RF generator to be used for multiple drying zones that are set to variable match network settings. Such a RF switch system can greatly reduce the overhead cost of producing a RF dryers, making efficient RF dryers more affordable for consumers.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of U.S.C. § 112(f) are not to be invoked unless the specific terms “means for” or “step for” are recited in a claim.

1. A radio frequency moisture-removal system configured to minimize temperature increases caused by radio frequency heating while increasing intermolecular hydrogen bond disruption, comprising:
a radio frequency generator;
a receptacle divided into at least two drying zones each drying zone having at least two capacitor plates with at least one capacitor plate configured to act as an emitter and at least one capacitor plate configured to act as a ground plate;
at least two radio frequency match networks each associated with and coupled to a corresponding drying zone;
a radio frequency switch system coupled to the radio frequency generator and the at least two radio frequency match networks, the radio frequency switch system configured to selectively route radio frequency waves generated by the radio frequency generator to each of the drying zones.

2. The radio frequency moisture-removal system of claim 1 further comprising a fan configured to remove moisture from the receptacle.

3. The radio frequency moisture-removal system of claim 1, further comprising a propane tank kept at an inlet of the receptacle to produce hot air for circulation in the receptacle.

4. The radio frequency moisture-removal system of claim 1 further comprising a hydraulic system configured to control the sizes of the at least two drying zones.

5. The radio frequency moisture-removal system of claim 1, wherein the receptacle is a cylindrical receptacle divided horizontally into the at least two drying zones.

6. The radio frequency moisture-removal system of claim 5, wherein the cylindrical receptacle contains a parallel capacitor plate configuration having five capacitor plates.

7. The radio frequency moisture-removal system of claim 6, wherein the parallel capacitor plate configuration includes two emitter sections configured to induce a voltage potential difference.

8. The radio frequency moisture-removal system of claim 1, wherein the receptable is a length-cuboid receptacle with a length as the dominant dimension.

9. The radio frequency moisture-removal system of claim 8 further comprising a second radio frequency generator coupled to the radio frequency switch system.

10. The radio frequency moisture-removal system of claim 9, wherein the radio frequency generators are configured to use an alternating heating pattern such that radio frequency waves from both radio frequency generators are never simultaneously routed to the same drying zone.

11. The radio frequency moisture-removal system of claim 1, wherein the receptable is a height-cuboid receptacle with a height as the dominant dimension.

12. The radio frequency moisture-removal system of claim 11, wherein the height-cuboid receptacle is vertically divided into drying zones based on the moisture content of received biomass material, wherein the residency time of the biomass material in each drying zone is adjusted such that each drying zone receives biomass material with a set moisture content.

13. The radio frequency moisture-removal system of claim 11, wherein the height-cuboid receptacle includes at least five capacitor plates.

14. The radio frequency moisture-removal system of claim 1, wherein the radio frequency switch system is configured to automatically switch between radio frequency match networks based on loss of a power signal.

15. The radio frequency moisture-removal system of claim 14, wherein an automatic switch between radio frequency match networks occurs at least every 500 milliseconds.

16. The radio frequency moisture-removal system of claim 14, wherein an automatic switch between radio frequency match networks occurs at least every minute.

17. The radio frequency moisture-removal system of claim 14, wherein the frequency of an automatic switch between radio frequency match networks is based on a set of material properties of biomass material received by the receptacle, the set of material properties including at least one of moisture of the biomass material at the point of the emitter, humidity of air within the receptacle, humidity of ambient air outside of the receptacle; temperature of air within the receptacle, temperature of ambient air outside of the receptacle; and airflow within the receptacle.

18. A radio frequency moisture-removal method, comprising:
producing, by a radio frequency generator, radio frequency waves;
routing, via a radio frequency switch system, the radio frequency waves to one of at least two radio frequency match networks, wherein each radio frequency match network is associated with and coupled to a corresponding drying zone of a receptacle configured to receive biomass material, each drying zone having at least two capacitor plates with at least one capacitor plate configured to act as an emitter and at least one capacitor plate configured to act as a grounding plate.

19. The radio frequency moisture-removal method of claim 18 further comprising, before producing radio frequency waves:
feeding biomass material into the receptacle with an auger system.

20. The radio frequency moisture-removal method of claim 18, wherein the radio frequency switch system is configured to automatically switch between radio frequency match networks based on loss of a power signal.
